(19) United States
(12) Patent Application Publication
(10) Pub. No.: US 2026/0093445 A1
(43) Pub. Date: Apr. 2, 2026

(54) Foldable Playback Device with Adaptive User Interface

(71) Applicant: Sonos, Inc., Goleta, CA (US)

(72) Inventors: Naphur van Apeldoorn, Amsterdam (NL); Job Koreman, Delft (NL); Timothy Scheek, Rotterdam (NL)

(21) Appl. No.: 19/341,790

(22) Filed: Sep. 26, 2025

Related U.S. Application Data
(60) Provisional application No. 63/700,324, filed on Sep. 27, 2024.

(51) Int. Cl. G06F 3/16; G06F 1/16; G06F 3/044

(52) U.S. Cl. CPC G06F 3/165; G06F 1/1616; G06F 1/1677; G06F 1/1681; G06F 3/044

(57) ABSTRACT

A foldable playback device comprises a first enclosure housing a first transducer, a second enclosure housing a second transducer, a hinge movably connecting the first and second transducers, and an adaptive user interface disposed on the hinge. The hinge enables movement of the first or second enclosures to position the foldable playback device in different physical orientations. The adaptive user interface enables controlling different playback and device settings while adapting to the different physical orientations to provide accessibility in any orientation. Based on evaluating environmental, media, or device characteristics, the foldable playback device may determine a given orientation for optimizing a playback experience, and may output an audio and/or a visual recommendation of the given orientation for manual positioning of the foldable playback device, or may dynamically position the foldable playback device in the given orientation.

### CROSS-REFERENCE TO RELATED APPLICATIONS

This application claims the benefit of priority to U.S. Provisional Application No. 63/700,324, filed September 27, 2024, and titled “Foldable Playback Device with Adaptive User Interface,” the contents of which are incorporated by reference herein in their entirety.

### FIELD OF THE DISCLOSURE

The present disclosure relates to consumer goods and, more particularly, to media playback or some aspect thereof.

### BACKGROUND

Wireless home sound systems can allow people to experience music from many sources via one or more networked playback devices. Through a program installed on a control device (e.g., smartphone, tablet, computer, or other device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Aspects and advantages of the technology disclosed herein may be better understood with regard to the following description, appended claims, and accompanying drawings, as listed below.

FIG. 1 is a plan view of an environment having a media playback system configured in accordance with aspects of the disclosed technology.

FIG. 2A is a schematic diagram of the media playback system of FIG. 1 and one or more networks, according to aspects of the disclosed technology.

FIG. 2B is a sequence diagram of a media playback system in accordance with aspects of the disclosed technology.

FIG. 3A is a diagram of a playback device in accordance with aspects of the disclosed technology.

FIG. 3B is a block diagram of a playback device in accordance with aspects of the disclosed technology.

FIG. 3C is a diagram of a user interface for a playback device in accordance with aspects of the disclosed technology.

FIG. 3D is a block diagram of voice processing circuitry that can be used in a playback device, according to aspects of the disclosed technology.

FIG. 4 is a partial block diagram of an example of a control device, in accordance with aspects of the disclosed technology.

FIGS. 5A-D are schematic diagrams of media playback system configurations, in accordance with aspects of the disclosed technology.

FIG. 6A is a diagram of a foldable playback device, according to one embodiment of the disclosed technology.

FIG. 6B is a diagram of an adaptive user interface of a foldable playback device, according to one embodiment of the disclosed technology.

FIGS. 7A-7H are schematic diagrams of different foldable playback device orientations, in accordance with aspects of the disclosed technology.

FIG. 8 is a flow diagram of example functionality for receiving playback commands via an adaptive user interface of a foldable playback device and updating an operational mode based on an orientation of the foldable playback device, according to aspects of the disclosed technology.

The drawings are for the purpose of illustrating examples. However, it will be understood that variations, including different and/or additional aspects and arrangements thereof, are possible, and that the technology disclosed herein is not limited to the arrangements and/or instrumentality shown in the drawings.

### DETAILED DESCRIPTION

### I. Overview

As technology related to media playback experiences continues to develop, the demands and expectations of modern listeners (e.g., users) also continue to evolve. For instance, consumer demand for media playback experiences on the go has given rise to portable media playback devices, and modern users expect portable media playback devices to offer audio quality, features, and processing capabilities on par with stationary media playback devices typically included in their networked media playback systems, while also being convenient to carry. Further, many modern users expect the capability to manage their media playback devices and be more actively involved with curating their listening experiences in a convenient and accessible way. While access to such customization and control options is often available by accessing a separate control device, such as a smartphone that is installed with a software application for controlling playback devices of a media playback system, relying solely on a control device to access control options is not always convenient or practical. In this respect, on-product user interfaces can provide an alternative means for conveniently controlling playback device behavior while alleviating reliance on a control device. However, such on-product user interfaces can be difficult to implement, particularly as playback devices become smaller and/or more portable to meet consumer needs.

Examples described herein relate to new hardware and software technology for a foldable playback device, an adaptive user interface disposed on a surface of the foldable playback device, and techniques for dynamic configuration of the foldable playback device based on different physical orientations of the foldable playback device.

In some examples, the disclosed foldable playback device may comprise a first transducer positioned within a first enclosure and a second transducer positioned within a second enclosure, and a hinge that movably connects the first enclosure and the second enclosure. In this respect, the hinge may enable the first and second transducers to be moved into different arrangements in order to position the foldable playback device in various orientations. For instance, as one example, in a first orientation, the first transducer and the second transducer may be arranged back-to-back. As another example, in a second orientation, the first transducer and the second transducer may be arranged side-by-side. Further, the foldable playback device may comprise a user interface positioned on the hinge, the user interface comprising at least one button. The user interface may be an adaptive user interface that contemplates the various orientations of the foldable playback device. Further yet, the foldable playback device may comprise, at least one processor, at least one non-transitory computer-readable medium, and program instructions stored on the at least one non-transitory computer-readable medium that are executable by the at least one processor such that the foldable playback device is configured to (i) receive a user input via the at least one button of the user interface, and (ii) based on the user input, execute an audio playback control command.

Some examples described herein may refer to functions performed by actors such as users and/or other individuals. Such references are for the purposes of explanation only. No claim should be interpreted to require action by any particular actor unless explicitly required by the language of the claim.

In the figures, identical reference numbers identify generally similar, and/or identical, elements. Many of the details, dimensions, angles, and/or other attributes shown in the figures are merely illustrative of particular examples of the disclosed technology. Accordingly, other examples can have other details, dimensions, angles, and/or attributes without departing from the scope of the disclosure. In addition, further examples of the disclosed technologies can be practiced without several of the details described below.

### II. Example Operating Environment

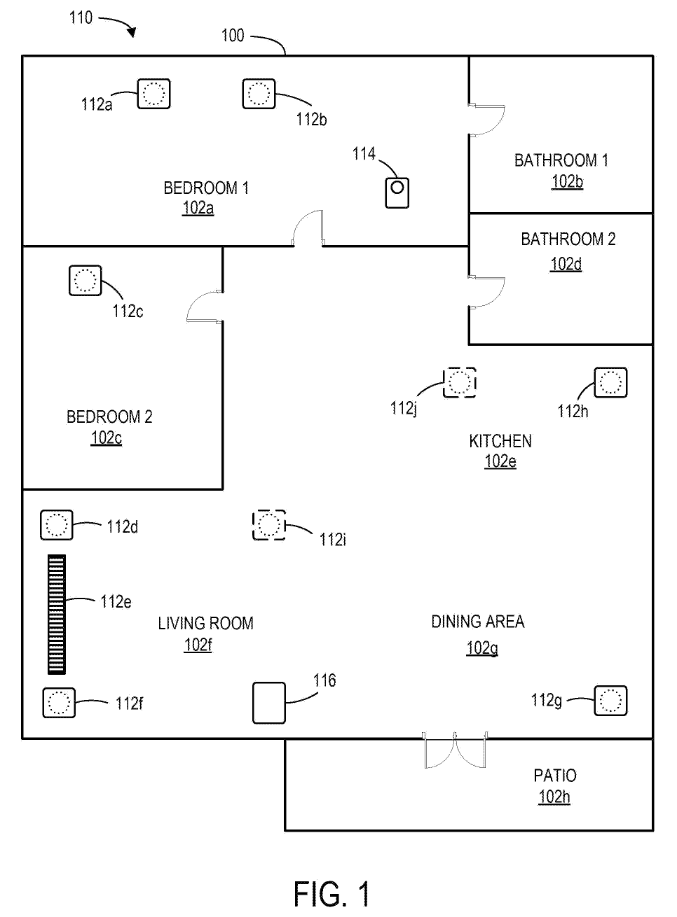

FIG. 1 is a plan (top) view of an environment 100 (e.g., a house) in which a media playback system 110 is installed. The media playback system 110 comprises one or more playback devices 112 (identified individually as playback devices 112a-j) and at least one control device 114. Examples of the playback devices 112 and control device 114 are described further below.

In the illustrated example of FIG. 1, the environment 100 comprises a household having several rooms and/or spaces, including a first bedroom 102a (“Bedroom 1”), a first bathroom 102b (“Bathroom 1”), a second bedroom 102c (“Bedroom 2”), a second bathroom 102d (“Bathroom 2”), a kitchen 102e, a living room 102f, a dining area 102g, and an outdoor patio 102h. Numerous other layouts and/or configurations of the environment 100 are possible, and the example illustrated in FIG. 1 is intended for the purpose of explanation only. Further, while certain examples are described below in the context of a home environment, the technologies described herein may be implemented in other types of environments. For example, the media playback system 110 can be implemented in one or more commercial settings (e.g., a restaurant, mall, airport, hotel, a retail or other store, etc.), one or more vehicles (e.g., a sports utility vehicle, bus, car, a ship, a boat, an airplane, etc.), multiple environments (e.g., a combination of home and vehicle environments), and/or another suitable environment where audio playback may be desirable.

As used herein the term “playback device” can generally refer to a network device configured to receive, process, and output data of a media playback system. For example, a playback device can be a network device that receives and processes audio content. In some examples, a playback device 112 includes one or more transducers or speakers powered by one or more amplifiers, as described further below. In other examples, however, a playback device includes one of (or neither of) the speaker(s) and/or the amplifier(s). For instance, a playback device 112 can comprise one or more amplifiers configured to drive one or more speakers external to the playback device via a corresponding wire or cable. In some examples, a playback device 112 includes one or more microphones and associated electronics configured for audio detection, as described further below. A playback device 112 that is configured for audio detection may be referred to in some instances as a network microphone device (NMD) or NMD-enabled playback device.

The term “control device” can generally refer to a network device configured to perform functions relevant to facilitating user access, control, and/or configuration of the media playback system 110. For example, the control device 114 can be configured to receive user input related to the media playback system 110 and, in response, cause one or more devices in the media playback system 110 to perform one or more actions or operations corresponding to the user input. In some examples, the control device 114 is a computing device (e.g., a computer, tablet, mobile phone, dedicated system controller, etc.) on which media playback system controller application software is installed. In some examples, the control device 114 is a user device, which may be a computing device having a human-accessible interface, such as a touch screen, voice-responsive interface, or other user-facing interface. Examples of a user device include a mobile phone with touch screen, tablet, personal computer, laptop computer, or dedicated system controller with a user interface. In some examples, the control device 114 is integrated into another device in the media playback system 110 (e.g., one or more of the playback devices 112), and/or another suitable device configured to communicate over a network (e.g., a television, automobile audio head unit, an internet of things (IoT) device, etc.). The control device 114 includes electronics configured to allow communication with one or more of the playback devices 112. In some examples, the control device 114 includes a display screen configured to display a graphical user interface through which a user can configure the media playback system 110 and/or control various functionality or operations of the media playback system 110, as described further below.

Some or all of the playback devices 112 are configured to receive audio signals or data from one or more media sources (e.g., one or more remote servers, one or more local devices, etc.) and to play back the received audio signals or data as sound. In some examples, one or more of the playback devices 112 are configured to receive spoken word commands, as described further below. The control device 114 is configured to receive user input and to control at least certain aspects of the media playback system 110 in response to the user input. For example, in response to the received spoken word commands and/or user input, the media playback system 110 can play back audio via one or more of the playback devices 112. In certain examples, the playback devices 112 are configured to commence playback of media content in response to a trigger condition. For instance, one or more of the playback devices 112 can be configured to play back a morning playlist upon detection of an associated trigger condition (e.g., presence of a user in the kitchen 102e at a certain time of day, etc.). In some examples, the media playback system 110 is configured to play back audio from a first playback device (e.g., the playback device 112a) in synchrony with a second playback device (e.g., the playback device 112b), as described in more detail below.

In some examples, one or more of the playback devices 112 (e.g., playback devices 112i and 112j in the example of FIG. 1) are portable playback devices, while others may be stationary playback devices. For example, the portable playback devices 112i and 112j may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like (such as the playback device 112e, for example) may be referred to herein as “stationary playback devices,” although such devices may in fact be moved around the environment 100. In practice, a person might often take a portable playback device to and from the environment 100, or to and from various locations within the environment 100, while the one or more stationary playback devices are rarely moved.

In some examples, the media playback system 110 includes a docking station (or charging station) 116 for charging any portable playback devices (e.g., the playback devices 112i, 112j). Accordingly, the portable playback devices 112i, 112j may comprise the docking station 116 and/or an interface configured to interact with the docking station 116. Each portable playback device (e.g., playback devices 112i and 112j) may have a dedicated docking station 116. In other examples, two or more portable playback devices 112i, 112j may share a common docking station 116.

Any one or more of the playback devices 112 may be stand-alone devices or may be integral to another device or component such as a television, an LP turntable, a lighting fixture, or some other device for indoor and/or outdoor use.

The media playback system 110 can comprise one or more playback spaces, some of which may correspond to rooms, portions of rooms, or combinations thereof, in the environment 100. The media playback system 110 can be established with one or more initial playback spaces, after which additional spaces may be added, and/or spaces may be removed, to form various configurations. Each playback space may be given a name, for example, according to a different room, combination of rooms, or other region within the environment 100, such as the first bedroom 102a, the dining area 102g, or living room 102f. In some aspects, a single playback space may include multiple rooms. In other aspects, a single room or portion of a room/region within the environment 100 may include multiple playback spaces. Each playback space can include one or more playback devices 112 that are grouped together, as described further below. In some examples, playback devices 112 in one or more playback spaces in the environment 100 can play the same or different audio content. In some examples, the playback devices 112 in two or more playback spaces can be configured to play the same audio content in synchrony with one another, such that a user perceives that the audio content is being played seamlessly (or at least substantially seamlessly) while moving around the environment 100.

### a. Example Media Playback System

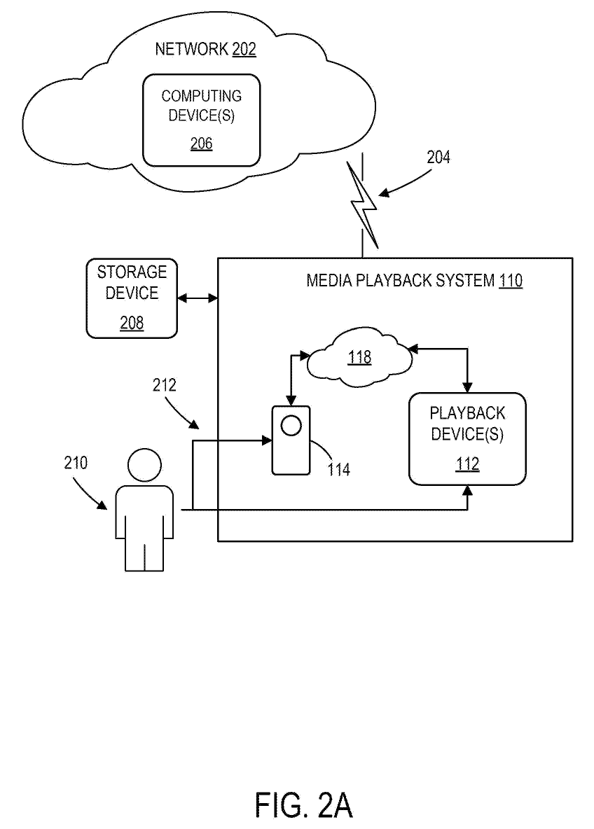

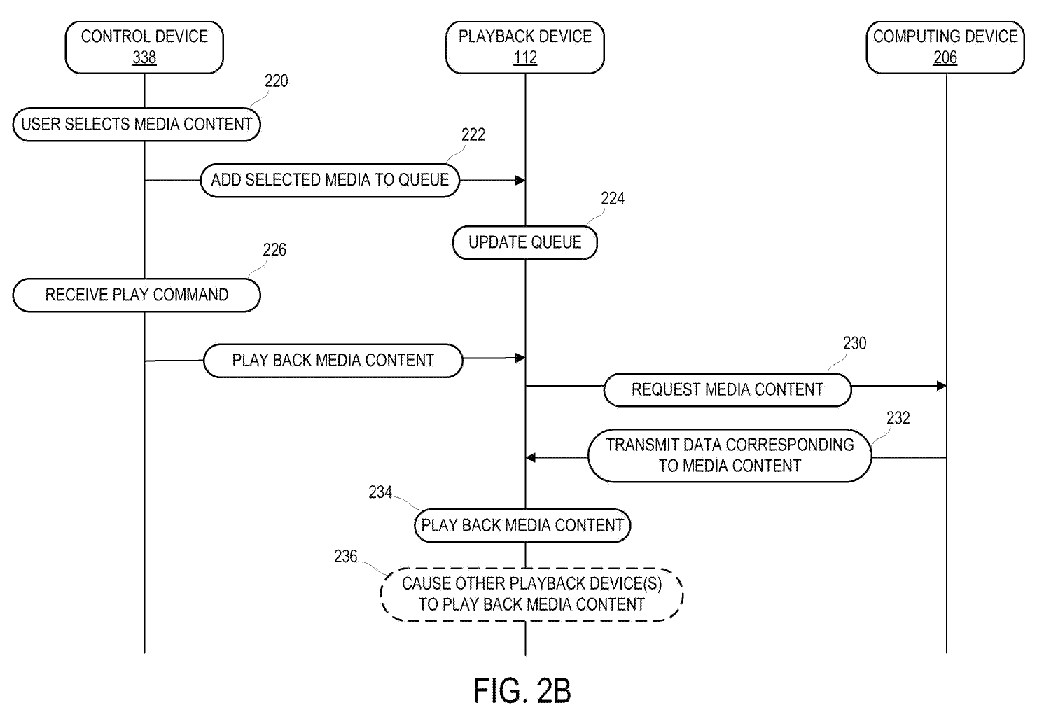

FIG. 2A is a schematic diagram of the media playback system 110 and a cloud network 202, according to certain examples. One or more communication links 204 (referred to herein as “the communication links”) communicatively couple the media playback system 110 and the cloud network 202. The communication links 204 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks, etc.). The cloud network 202 may deliver media content (e.g., audio content, video content, photographs, social media content, etc.) to the media playback system 110 in response to a request transmitted from the media playback system 110 via the communication links 204. In some examples, the cloud network 202 is further configured to receive data (e.g., voice input data and/or other data) from the media playback system 110 and correspondingly transmit commands and/or media content to the media playback system 110.

The cloud network 202 comprises one or more computing devices 206 (referred to herein as “the computing devices”). The computing devices 206 can comprise one or more individual computers or servers, such as, for example, a media streaming service server storing audio and/or other media content, a voice service server, a social media server, a media playback system control server, etc. In some examples, the computing devices 206 comprise one or more parts of a single computer or server. In some examples, the computing devices 206 comprise one or computers, servers, and/or other circuitry. Moreover, while the cloud network 202 is described above in the context of a single cloud network, in some examples the cloud network 202 comprises a plurality of cloud networks comprising communicatively coupled computing devices 206.

The media playback system 110 is configured to receive media content from the cloud network 202 via the communication links 204. The received media content can comprise, for example, a Uniform Resource Identifier (URI) and/or a Uniform Resource Locator (URL). For example, the media playback system 110 can stream, download, or otherwise obtain data via a URI or a URL corresponding to the received media content. A network 118 communicatively couples the communication links 204 and at least some of the devices (e.g., one or more of the playback devices 112 and/or the control device 114) of the media playback system 110. The network 118 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ad, 802.11af, 802.11ah, 802.11ai, 802.11aj, 802.11aq, 802.11ax, 802.11ay, 802.15, etc. transmitted at one or more frequencies in the 2.4 Gigahertz (GHz), 5 GHz, 6 GHz, and/or another suitable, frequency band.

In some examples, the network 118 comprises a dedicated communication network that the media playback system 110 uses to transmit messages between individual devices and/or to transmit media content to and from media content sources (e.g., the computing devices 206). In certain examples, the network 118 is configured to be accessible only to devices in the media playback system 110, thereby reducing interference and competition with other household devices. In other examples, however, the network 118 comprises an existing household or commercial facility communication network (e.g., a household or commercial facility WI-FI network). In some examples, the communication links 204 and the network 118 comprise one or more of the same networks. For example, the communication links 204 and the network 118 may comprise a telecommunications network (e.g., an LTE network, a 5G network, etc.). Moreover, in some examples, the media playback system 110 is implemented without the network 118, and devices comprising the media playback system 110 can communicate with each other, for example, via one or more direct connections, PANs, telecommunication networks, and/or other suitable communication links. In some examples, the network 118 is (or includes) a LAN implemented within, or partially within, the environment 100.

In some examples, audio content sources may be regularly added or removed from the media playback system 110. In some examples, the media playback system 110 performs an indexing of media items when one or more media content sources are updated, added to, and/or removed from the media playback system 110. The media playback system 110 can scan identifiable media items in some or all folders and/or directories accessible to the playback devices 112 and generate or update a media content database comprising metadata (e.g., title, artist, album, track length, etc.) and other associated information (e.g., URIs, URLs, etc.) for each identifiable media item found. For example, the media content database may be stored on one or more of the playback devices 112, a local storage device 208 (that may be part of, or communicatively coupled to, one or more devices in the media playback system 110), and/or the control device 114. In some examples, the local storage device 208 is part of a computing device that is accessible to the media playback system 110 (e.g., via the network 118 or via another wired or wireless communication link).

In some examples, one or more devices in the media playback system 110 can be configured to receive input or control signals 212 from a user 210. These control signals 212 can be detected via a user interface on the control device 114 and/or on one or more of the playback devices 112, as described further below. In some examples, one or more of the playback devices 112 include a microphone and other circuitry configured to receive at least some of the control signals 212 as voice input from the user 210, as described further below. In some examples, the control device 114 is configured to receive at least some of the control signals 212 as voice input from the user 210.

FIG. 2B is a sequence diagram illustrating data exchanges between devices of the media playback system 110, according to certain examples.

At step 220, the media playback system 110 receives an indication of selected media content (e.g., one or more songs, albums, playlists, podcasts, videos, stations) via the control device 114. The selected media content can comprise, for example, media items stored locally on one or more devices (e.g., the storage device 208) connected to the media playback system 110 and/or media items stored on one or more media services (hosted by one or more of the computing devices 206). In response to receiving the indication of the selected media content, the control device 114 transmits a message 222 to the playback device 112 to add the selected media content to a playback queue on the playback device 112.

At step 224, the playback device 112 receives the message 222 and adds the selected media content to the playback queue for playback.

At step 226, the control device 114 receives input corresponding to a command to play back the selected media content. In response to receiving the input corresponding to the command to play back the selected media content, the control device 114 transmits a message 228 to the playback device 112 causing the playback device 112 to play back the selected media content. In response to receiving the message 228, the playback device 112 transmits a message 230 to at least one of the computing devices 206 requesting the selected media content. The message may specify, for example, a URL or a URI corresponding to the selected media content. The computing device 206, in response to receiving the message 230, transmits a message or stream 232 comprising data (e.g., audio data, video data) corresponding to the requested media content.

At step 234, the playback device 112 receives the message or stream 232 with the data corresponding to the requested media content and plays back the associated media content.

At step 236, the playback device 112 optionally causes one or more other devices to play back the selected media content. In some examples, the playback device 112 is a member device of a group comprising two or more playback devices, as described below with reference to FIG.s 5A-CD. In such an example, the playback device 112 can receive the selected media content and transmit all or a portion of the media content to other playback devices in the group. The other one or more devices in the group can receive the selected media content from the computing devices 206 (or from the playback device 112), and begin playback of the selected media content in response to a message from the playback device 112 such that all of the devices in the group play back the selected media content in synchrony. Additional details regarding audio playback synchronization among playback devices and/or zones can be found, for example, in U.S. Patent No. 8,234,395 titled, “System and method for synchronizing operations among a plurality of independently clocked digital data processing devices,” which is incorporated herein by reference in its entirety.

### b.Example Playback Devices

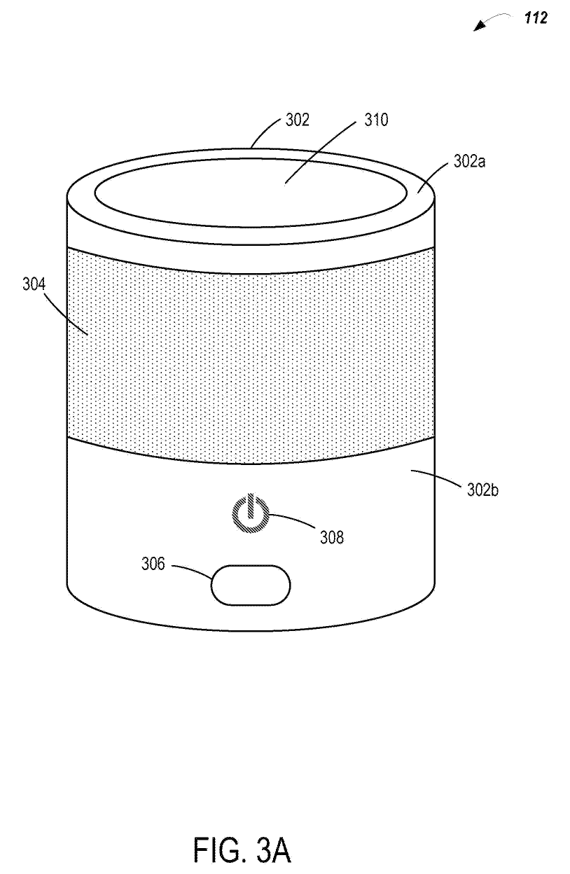

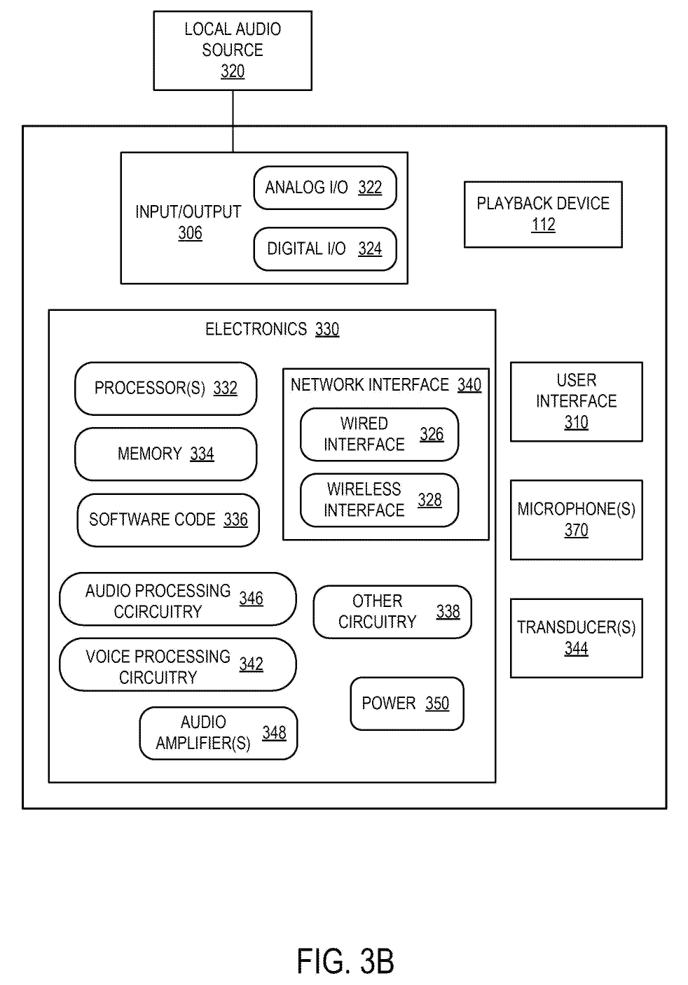

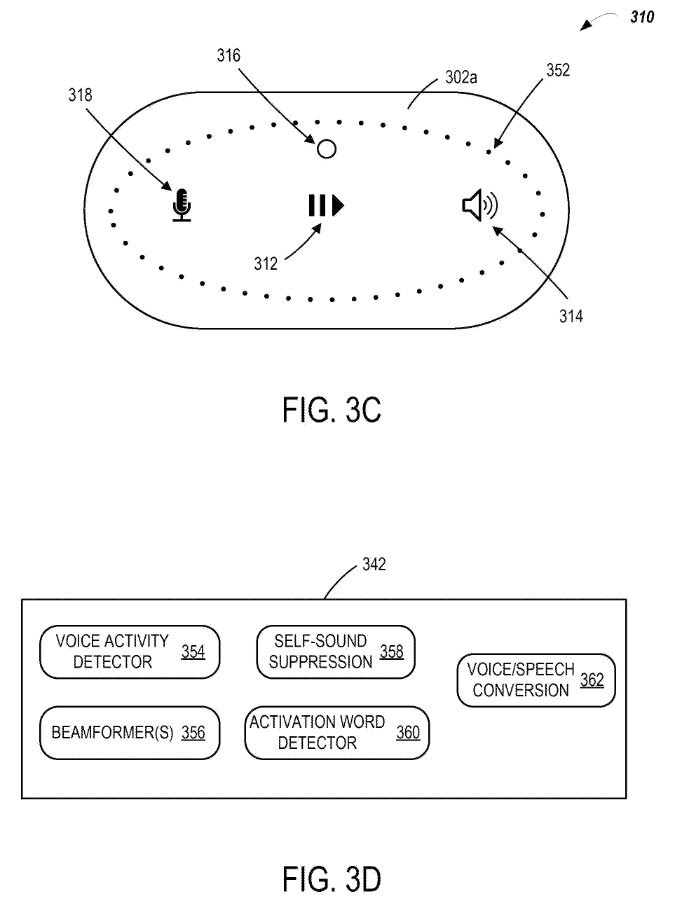

FIG. 3A is a diagram illustrating a playback device 112 according to certain examples. The playback device 112 includes a housing 302 that houses a plurality of components, as described further below. The housing 302 includes a plurality of surfaces, such as a top surface 302a and one or more side surfaces 302b. In the illustrated example of FIG. 3A, the housing 302 has a cylindrical shape; however, in other examples, the housing 302 may have a different shape, such as rectangular, square, trapezoidal, or other shape. Furthermore, in various examples the housing 302 may have an aspect ratio other than as illustrated in FIG. 3A. For example, the housing 302 may have an elongated form factor (e.g., longer in the X dimension than in the Y or Z dimensions). In other examples, the playback device 112 may comprise wired or wireless headphones (e.g., over-the-ear headphones, on-ear headphones, in-ear earphones, etc.), and thus the housing 302 may comprise two or more housings or housing components (e.g., earcups, earbuds, and/or a headband) that may be separate or coupled together. Numerous variations are envisioned and intended to be part of this disclosure.

In some examples, the housing 302 includes a grille 304. In the example of FIG. 3A, the grille 304 is shown extending over a portion of the side surface 302b; however, in other examples the grille 304 may cover an entire region of, or portion of, one or more side surfaces of the housing 302 and/or the top surface 302a of the housing 302. The grille 304 may include perforations, ports, or other openings, to allow sound (e.g., acoustic energy) from one or more transducers housed within the housing 302 to be emitted from the playback device 112.

In some examples, the playback device 112 includes an input/output 306 configured to allow the playback device 112 to be connected to and/or communicate with another device, as described further below. In some examples, the playback device 112 can receive operating power via the input/output 306 (e.g., through connection to a mains outlet or other electrical power supply). Although the input/output 306 is illustrated in FIG. 3A as a single object, the input/output 306 may include multiple ports, interfaces, connectors, cables, antennas, and/or other components, as described further below.

The playback device 112 may further include a power button (or switch) 308 configured to allow a user to turn the playback device 112 on and off. In some examples, the power button 308 includes a light or other visual indicator that indicates whether the playback device 112 is on, off, or in some other state (e.g., on, but in a sleep state). In the example illustrated in FIG. 3A, the power button and the input/output 306 are illustrated as located on the side surface 302b of the housing 302; however, in other examples, the power button 308 may be located on a different surface of the housing than the input/output 306.

In some examples, the playback device 112 includes a user interface 310 configured to allow a user to interact with, and optionally control various functionality of, the playback device 112, as described further below. In the example illustrated in FIG. 3A, the user interface 310 is shown on the top surface 302a of the housing 302; however, in other examples, the user interface 310 may include one or more components located on other surfaces of the housing 302. For example, the power button 308 may be part of the user interface 310.

Turning now to FIG. 3B, illustrated is a block diagram of the playback device 112 according to certain examples. In the illustrated example, the playback device 112 includes the input/output 306, the user interface 310, and electronics 330. The playback device 112 may optionally include one or more microphones 370 (e.g., a single microphone, a plurality of microphones, a microphone array, etc.; referred to herein as “the microphones 370”) and/or one or more audio transducers 344 (referred to hereinafter as “the transducers 344” or “the audio transducers 344”).

The input/output (I/O) 306 can include an analog I/O 322 (e.g., one or more wires, cables, and/or other suitable communication links configured to carry analog signals) and/or a digital I/O 324 (e.g., one or more wires, cables, or other suitable communication links configured to carry digital signals). In some examples, the analog I/O 322 is an audio line-in input connection comprising, for example, an auto-detecting 3.5 millimeter (mm) audio line-in connection. In some examples, the digital I/O 324 comprises a Sony/Philips Digital Interface Format (S/PDIF) communication interface and/or cable (or cable connection), and/or a Toshiba Link (TOSLINK) cable (or cable connection). In some examples, the digital I/O 324 comprises a High-Definition Multimedia Interface (HDMI) interface and/or cable. In some examples, the digital I/O 324 includes one or more wireless communication links comprising, for example, a radio frequency (RF), infrared, WI-FI, BLUETOOTH, or another suitable communication link. The analog I/O 322 and the digital I/O 324 may comprise interfaces (e.g., ports, plugs, jacks, etc.) configured to receive connectors of cables transmitting analog and digital signals, respectively, without necessarily including cables.

In some examples, the playback device 112 receives media content (e.g., audio content comprising music, speech, and/or other sounds) from a local audio source 320 via the input/output 306 (e.g., a cable, a wire, a PAN, a BLUETOOTH connection, an ad hoc wired or wireless communication network, and/or another suitable communication link). The local audio source 320 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 320 includes local music libraries on a smartphone, a computer, a networked-attached storage (NAS), and/or another suitable device (e.g., the storage device 208) configured to store media files. In certain examples, one or more of the playback devices 112 and/or the at least one control device 114 comprise the local audio source 320. In other examples, however, the media playback system 110 omits the local audio source 320 altogether. In some examples, the playback device 112a does not include the input/output 306 and receives all audio content via the network 118. In other examples, the playback device 112 receives operating power via the input/output 306 and receives all audio content via the network 118.

According to certain examples, the electronics 330, are configured to receive audio from an audio source (e.g., the local audio source 320) via the input/output 306 or from one or more of the computing device(s) 206 via the network 118, amplify the received audio, and output the amplified audio for playback via one or more of the transducers 344. In the illustrated example of FIG. 3B, the electronics 330 comprise one or more processors 332 (referred to hereinafter as “the processors 332”), memory 334, software code 336, a network interface 340, audio processing circuitry 346, one or more audio amplifiers 348 (referred to hereinafter as “the amplifiers 348”), and power 350 (e.g., one or more power supplies, batteries, power cables, power receptacles, batteries, induction coils, Power-over Ethernet (POE) interfaces, and/or other suitable sources of electric power). The power 350 may be coupled to the power button 308. In some examples, the electronics 330 optionally include other circuitry 338 (e.g., one or more sensors, video displays, touchscreens, battery charging bases, cameras, thermometers, barometers, hygrometers, etc.). In some examples, the electronics 330 optionally include voice processing circuitry 342, as described further below.

The processors 332 can comprise clock-driven computing devices configured to process data, and the memory 334 can comprise a computer-readable medium (e.g., a tangible, non-transitory computer-readable medium loaded with at least some of the software code 336) configured to store instructions for performing various operations and/or functions. The processors 332 are configured to execute the instructions stored on the memory 334 to perform one or more of the operations. The operations can include, for example, causing the playback device 112 to retrieve audio data from an audio source (e.g., one or more of the computing devices 206 or the local audio source 320), and/or from another playback device 112. In some examples, the operations further include causing the playback device 112 to send audio data to another playback device 112. Certain examples include operations causing the playback device 112 to pair with another playback device 112 to enable a multi-channel audio environment (e.g., bonded group, such as a stereo pair, etc.), as described further below.

The processors 332 can be further configured to perform operations causing the playback device 112 to synchronize playback of audio content with another one or more playback devices 112. During synchronous playback of audio content on a plurality of playback devices, a listener will preferably be unable to perceive time-delay differences between playback of the audio content on the various playback devices 112.

In some examples, the memory 334 is further configured to store data associated with the playback device 112, such as one or more groups of which the playback device 112 is a member, audio sources accessible to the playback device 112, and/or a playback queue that the playback device 112 (and/or another one or more playback devices) can be associated with. The stored data can comprise one or more state variables that are periodically updated and used to describe a state of the playback device 112. The memory 334 can also include data associated with a state of one or more of the other devices (e.g., the playback devices 112 and/or control device 114) of the media playback system 110. In some examples, the state data is shared during predetermined intervals of time (e.g., every 5 seconds, every 10 seconds, every 60 seconds, etc.) among at least some of the devices of the media playback system 110, so that one or more of the devices have the most recent data associated with the media playback system 110.

Continuing with the example of FIG. 3B, the network interface 340 is configured to facilitate transmission of data between the playback device 112 and one or more other devices on a data network such as, for example, the communication links 204, the cloud network 202, and/or the network 118. The network interface 340 is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 340 can parse the digital packet data such that the electronics 330 properly receive and process the data destined for the playback device 112.

In some examples, the network interface 340 includes a wireless interface 328. The wireless interface 328 (e.g., a suitable interface comprising one or more antennae) can be configured to wirelessly communicate with one or more other devices (e.g., one or more other playback devices 112 and/or the control device 114) that are communicatively coupled to the network 118 in accordance with a suitable wireless communication protocol (e.g., WI-FI, BLUETOOTH, LTE, etc.). In some examples, the network interface 340 optionally includes a wired interface 326 (e.g., one or more interfaces, ports, or receptacles configured to receive a network cable such as an Ethernet, USB-A, USB-C, and/or Thunderbolt cable) configured to communicate over a wired connection with other devices in accordance with a suitable wired communication protocol. In certain examples, the network interface 340 includes the wired interface 326 and omits the wireless interface 328. In some examples, some or all of the components of the input/output 306 form part of the network interface 340, or vice versa. In other examples, the electronics 330 may omit the network interface 340 and transmit and receive media content and/or other data via another communication path (e.g., the input/output 306).

Still referring to FIG. 3B, the audio processing circuitry 346 is configured to process and/or filter data comprising media content received by the electronics 330 (e.g., via the input/output 306 and/or the network interface 340) to produce output audio signals. In some examples, the audio processing circuitry 346 comprises one or more digital-to-analog converters (DACs), audio enhancement circuitry, digital signal processors (DSPs), filters, and/or other suitable audio processing circuitry. In certain examples, the audio processing circuitry 346 can comprise one or more subcomponents of the processors 332. In some examples, the electronics 330 omit the audio processing circuitry 346. For example, the processors 332 may execute instructions stored on the memory 334 to perform audio processing operations to produce the output audio signals.

The amplifiers 348 are configured to receive and amplify the audio output signals produced by the audio processing circuitry 346 and/or the processors 332. The amplifiers 348 can comprise electronic devices and/or circuitry configured to amplify audio signals to levels sufficient for driving one or more of the transducers 344. For example, the amplifiers 348 may include one or more switching or class-D power amplifiers. In other examples, however, the amplifiers 348 include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain examples, the amplifiers 348 comprise a suitable combination of two or more of the foregoing types of power amplifiers. Moreover, in some examples, individual ones of the amplifiers 348 correspond to individual ones of the transducers 344. In other examples, however, the electronics 330 include a single one of the amplifiers 348 configured to output amplified audio signals to a plurality of the transducers 344. In some other examples, the electronics 330 omit the amplifiers 348.

The transducers 344 (e.g., one or more speakers and/or speaker drivers) are configured to receive electrical signals from the electronics 330 and to convert the received electrical signals into audible sound during playback. For example, the transducers 344 may be configured to receive the amplified audio signals from the amplifiers 348 and render or output the amplified audio signals as sound (e.g., audible sound waves having a frequency between about 20 Hertz (Hz) and 20 kilohertz (kHz)). In some examples, the transducers 344 can comprise a single transducer. In other examples, however, the transducers 344 comprise a plurality of audio transducers. In some examples, the transducers 344 comprise more than one type of transducer. For example, the transducers 344 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 344 comprise transducers that do not adhere to the foregoing frequency ranges. For example, one of the transducers 344 may comprise a mid-woofer transducer configured to output sound at frequencies between about 200 Hz and about 5 kHz. In some examples in which the transducers 344 include multiple transducers, all or some of the transducers can be configured to operate as a phased array to desirably adjust (e.g., narrow or widen) a radiation pattern of the transducers 344, thereby altering a user’s perception of the sound emitted from the playback device 112. Furthermore, in some examples, the transducers 344 include one or more transducers configured to emit signals in a frequency range that is not audible to typical human listeners (e.g., ultrasonic signals). In other examples, the playback device 112 may omit the transducers 344.

The user interface 310 may include a plurality of control surfaces (e.g., buttons, dials, touch-sensitive surfaces (such as capacitive surfaces, for example), knobs, etc.) that allow a user to control various aspects of the playback device 112. Referring to FIG. 3C, in some examples, the user interface 310 includes one or more first control surfaces 312 that allow a user to control playback operations of the playback device 112 (e.g., “pause,” “play,” “skip,” “next,” “previous” or “repeat,” etc.) and one or more second control surfaces 314 for volume control. The user interface 310 may include one or more indicators 316 (e.g., one or more light emitting diodes (LEDs) or another suitable illuminator) that can be configured to indicate various statuses and/or operations of the playback device 112. For example, the one or more indicators 316 may illuminate, change color, flash, etc., in response to certain conditions, such as to indicate a power state, wireless connectivity (e.g., BLUETOOTH connection and/or pairing), or other conditions. In some examples, the one or more indicators 316 can be combined with one or more control surfaces. For example, the power button 308 may include an indicator that indicates (e.g., through illumination or color of illumination) a power state of the playback device 112. In examples in which the playback device 112 includes the microphones 370, the user interface 310 may include one or more microphone control surfaces and/or indicators 318. For example, the microphone control surfaces and/or indicators 318 may allow a user to activate or deactivate the microphones 370. In some examples, the microphone control surfaces and/or indicators 318 may illuminate only when the one or more microphones 370 are activated. In further examples, the microphone control surfaces and/or indicators 318 can include one or more indicators (e.g., one or more LEDs) that can be configured to remain solid during normal operation and to blink or otherwise change from solid to indicate a detection of voice activity.

It will be appreciated that the user interface 310 may include more or fewer control surfaces and/or illuminators than those illustrated in FIG. 3C. In addition, the user interface 310, or some components thereof, need not be positioned on the top surface 302a of the housing 302, but may be positioned elsewhere on/in the housing 302. Numerous variations are envisioned and intended to be part of this disclosure.

Referring again to FIG. 3B, as described above, in some examples, the playback device 112 includes the microphones 370 and can be configured to detect (and optionally respond to) sounds, such as voice input from the user 210. Accordingly, in such examples, the electronics 330 include voice processing circuitry 342. In some examples, the microphones 370 are configured to acquire, capture, and/or receive sound from an environment (e.g., the environment 100) and/or a room in which the playback device 112 is positioned. The received sound can include, for example, vocal utterances (e.g., by the user 210), audio played back by the playback device 112 and/or another playback device, background voices, ambient sounds, etc. Accordingly, in some examples, the housing 302 of the playback device 112 includes a plurality of ports, holes or apertures 352, as shown in FIG. 3C, to allow sound to pass through to the microphones 370 contained within the housing 302. In some examples, the apertures 352 are positioned on/in the top surface 302a of the housing 302, as shown in FIG. 3C; however, in other examples, the apertures 352 may be positioned on/in other surfaces of the housing 302. The microphones 370 are configured to receive sound via the apertures 352 and to convert the received sound into electrical signals to produce microphone data.

The voice processing circuitry 342 receives and analyzes the microphone data to determine whether a voice input is present in the microphone data. The voice input can comprise, for example, an activation word followed by an utterance including a user request. An activation word is a word or other audio cue signifying a user voice input. An activation word can be used as a trigger to invoke a corresponding voice assistant service (VAS). For instance, in querying the AMAZON VAS, a user might speak the activation word “Alexa.” Other examples include “Ok, Google” for invoking the GOOGLE VAS and “Hey, Siri” for invoking the APPLE VAS. After detecting an activation word, for example, the voice processing circuitry 342 monitors the microphone data for an accompanying user request in the voice input. The user request may include, for example, a command to control certain operation of the playback device 112 and/or of another playback device (e.g., to start or stop playback of certain audio content or to alter the volume of playback), or to control (e.g., turn on or off or adjust) another device, such as a thermostat or an illumination device, for example. In some examples, after detection of one or more suitable voice commands, the playback device 112 is configured to transmit data associated with the received voice input to another device and/or a remote server (e.g., one or more of the computing devices 206) for further analysis. For example, the computing devices 206 may include a VAS server and/or otherwise operate a VAS configured to (i) process the received voice input data and (ii) facilitate one or more operations on behalf of the media playback system 110. Additional details regarding voice processing can be found, for example, in U.S. Patent No. 10,499,146, titled “Voice control of a media playback system,” which is incorporated by reference herein in its entirety.

Referring to FIG.s 2A and 3B, in some examples, one or more of the computing devices 206, using the VAS, may analyze the data received from the playback device 112, determine an appropriate action based on the voice command, and transmit a message to the playback device 112 to perform the appropriate action. For instance, the user 210 may speak “[activation word], play [song title] or [artist].” The playback device 112 can, via the microphones 370 and the voice processing circuitry 342, record the user’s voice utterance, determine the presence of a voice command, and transmit, via the communication links 204, the audio data having the voice command to the computing devices 206. The computing devices 206 may analyze the audio data and determine an action corresponding to the command. The computing devices 206 may then transmit a command to the playback device 112 to perform the determined action (e.g., play back audio content related to the specified song title or artist). The playback device 112 can receive the command and play back the audio content from a media content source and/or cause another playback device to play back the audio content from the media content source. As described above with respect to FIG. 2A, suitable content sources can include a device or storage (e.g., the storage device 208) communicatively coupled to the playback device 112 via the network 118, or the remote computing devices 206, for example. In other examples, the computing devices 206 may be configured to interface with media services on behalf of the media playback system 110. For example, after processing the voice input, instead of the computing devices 206 transmitting commands to the playback device 112 causing the media playback system 110 to retrieve the requested media from a suitable media service, the computing devices 206 may cause a suitable media service to provide the requested media to the media playback system 110 in accordance with the user’s voice utterance. In other examples, the playback device 112 determines and/or performs one or more actions corresponding to the one or more voice commands without intervention or involvement of an external device, computer, or server (such as the computing devices 206).

Referring to FIG. 3D, in some examples, the voice processing circuitry 342 includes circuitry configured to facilitate voice command capture, including a voice activity detector 354, one or more beamformers 356 (referred to herein as “the beamformers”), acoustic echo cancellation (AEC) and/or self-sound suppression circuitry 358, an activation word detector 360, and voice/speech conversion circuitry 362 (e.g., voice-to-text and text-to-voice). In the example illustrated in FIG. 3D, the aforementioned parts of the voice processing circuitry 342 are shown as separate elements; however, as described above, some or all of the voice processing circuitry 342 can be implemented as subcomponents of the processors 332.

In some examples, the beamformers 356 and self-sound suppression circuitry 358 are configured to detect an audio signal and determine aspects of voice input represented in the detected audio signal, such as the direction, amplitude, frequency spectrum, etc. The voice activity detector 354 is operably coupled with the beamformers 356 and self-sound suppression circuitry 358 and configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is a measure of spectral structure. As those of ordinary skill in the art will appreciate, speech typically has a lower entropy than most common background noise.

The activation word detector 360 is configured to monitor and analyze received audio to determine if any activation words (e.g., wake words) are present in the received audio. The activation word detector 360 may analyze the received audio using an activation word detection process. If the activation word detector 360 detects an activation word, the playback device 112 may process voice input contained in the received audio. Example activation word detection processes accept audio as input and provide an indication of whether an activation word is present in the audio. Many activation word detection processes are known and commercially available. In some examples, the activation word detector 360 runs multiple activation word detection processes on the received audio simultaneously (or substantially simultaneously). As noted above, different voice services can use different activation words for invoking their respective voice service. To support multiple services, the activation word detector 360 may run the received audio through the activation word detection process for each supported voice service in parallel, for example.

The speech/text conversion circuitry 362 may facilitate processing by converting speech in the voice input to text. In some examples, the electronics 330 can include voice recognition software that is trained to a particular user or a particular set of users associated with a household. Such voice recognition software may implement voice-processing that is tuned to specific voice profile(s). Services tuned to specific voice profiles may be less computationally intense than traditional voice activity services, which typically sample from a broad base of users and diverse requests that are not targeted to media playback systems.

### c.Example Control Devices

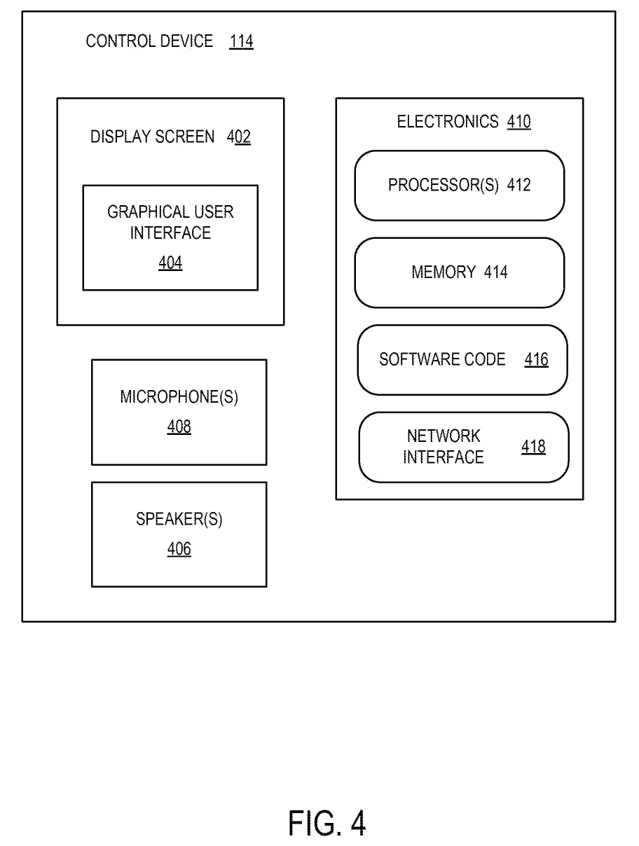

FIG. 4 is a partial schematic diagram of the control device 114, according to certain examples. As described above, the control device 114 may be a computing device, such as a mobile phone, for example, or may be a dedicated controller associated with the media playback system 110. In some examples, the control device 114 can be integrated with a playback device 112 or other electronic device.

In some examples, the control device 114 includes a display screen 402 that is configured to present a graphical user interface 404. The control device 114 may further include one or more speakers 406 configured to output sound to the user 210 of the control device, and one or more microphones 408 to capture voice input from the user 210. The control device further comprises electronics 410 for operation of the control device 114. In some examples, the electronics 410 comprise one or more processors 412 (referred to hereinafter as “the processors 412”), a memory 414, software code 416, and a network interface 418. The processors 412 can be configured to perform functions relevant to facilitating user access, control, and configuration of the media playback system 110. The memory 414 can comprise data storage that can be loaded with the software code 416 executable by the processors 412 to perform those functions. The software code 416 can comprise applications and/or other executable software configured to facilitate control of the media playback system 110. The memory 414 can be configured to store, for example, the software code 416, media playback system controller application software, and/or other data associated with the media playback system 110 and the user.

The network interface 418 is configured to facilitate network communications between the control device 114 and one or more other devices in the media playback system 110, and/or one or more remote devices (e.g., the computing devices 206). In some examples, the network interface 418 includes a wireless interface, such as the wireless interface 328 described above with reference to FIG. 3B, for example. The network interface 418 can be configured, for example, to transmit data to and/or receive data from the playback devices 112, the computing devices 206, and/or other devices. The transmitted and/or received data can include, for example, playback device control commands, state variables, playback space and/or playback group configurations. For instance, based on user input received via the graphical user interface 404, the network interface 418 can transmit a playback device control command (e.g., volume control, audio playback control, audio content selection, etc.) from the control device 114 to one or more of the playback devices 112. The network interface 418 can also transmit and/or receive configuration changes such as, for example, adding/removing one or more playback devices 112 to/from a group, adding/removing one or more groups of playback devices to/from a combination group or area, forming bonded or consolidated groups, and/or separating one or more playback devices 112 from a bonded group, among others.

The graphical user interface 404 is configured to receive user input and can facilitate control of the media playback system 110. The graphical user interface 404 may display information, such as media content art (e.g., album art, lyrics, videos, etc.),a playback status indicator (e.g., an elapsed and/or remaining time indicator), media content information (e.g., title, artist, album, genre, etc.), and/or other information. The graphical user interface 404 may present one or more control regions that can include selectable (e.g., via touch input and/or via a cursor or another suitable selector) icons or other control elements to allow the user 210 to control the media playback system 110. For example, the graphical user interface 404 may present control icons to cause one or more playback devices in a selected playback space or playback group to perform playback actions such as, for example, play or pause, fast forward, rewind, skip to next, skip to previous, enter/exit shuffle mode, enter/exit repeat mode, enter/exit crossfade mode, etc. A playback control region may also include selectable icons to modify equalization settings, playback volume, and/or other suitable playback actions. It will be appreciated, given the benefit of this disclosure, that user interfaces of varying formats, styles, and interactive sequences may be implemented on the control device 114 to provide control access to a media playback system. In some examples, the control device 114 may include other user interface components in addition to the graphical user interface 404. In other examples, the control device 114 may omit the graphical user interface 404.

It will further be appreciated that in some examples, the control device 114 may include additional circuitry not shown in FIG. 4, and/or may omit any of the circuitry shown in FIG. 4. For example, the control device 114 may omit the one or more speakers 406 and/or the one or more microphones 408. In some examples, the control device 114 may comprise a device (e.g., a thermostat, an IoT device, a network device, etc.) comprising a portion of the electronics 410 and the graphical user interface 404 (e.g., presented via the display screen 402 implemented as a touch screen) without any speakers or microphones. In examples in which the control device 114 comprises a device configured for functionality beyond control of the media playback system 110, the control device 114 may include various circuitry and electronic and/or other components associated with its other functionality.

### d.Suitable Playback Device Configurations

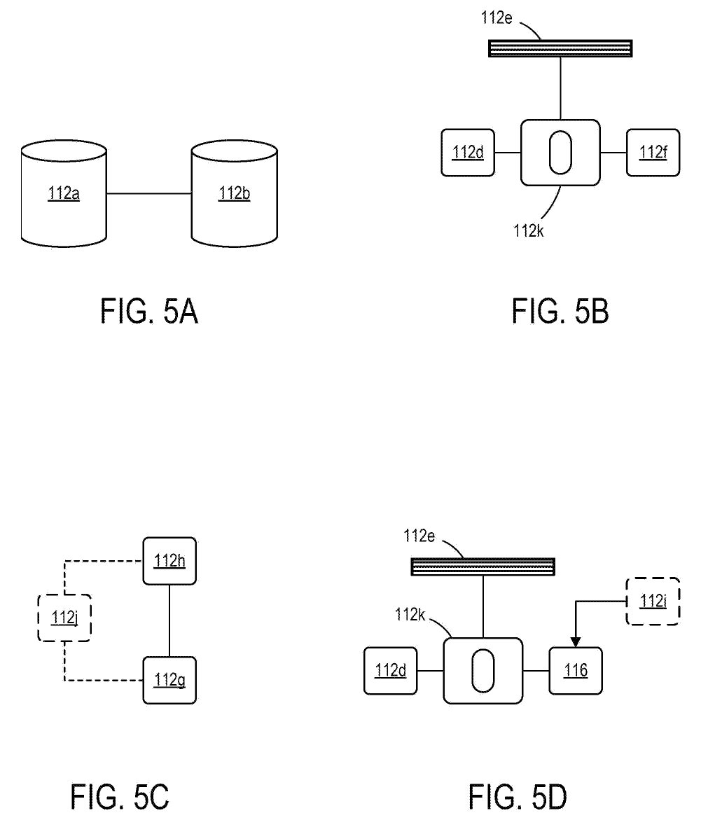

FIGS. 5A-D show example configurations of playback devices 112 groups. As described above, playback devices 112 may be assigned to various groups and/or playback spaces within the environment 100. For example, the playback devices 112a and 112b in Bedroom 1 may be assigned to one group (or playback space), and the playback device 112c in Bedroom 2 may be assigned to another group (or playback space). In some examples, the playback devices 112 within a group play audio content in synchrony. For example, two or more playback devices 112 in a group can play back the same audio content in synchrony with one another. In some examples, two or more playback devices 112 can be “bonded” to form a bonded group. Playback devices in a bonded group may have different playback responsibilities (e.g., channel responsibilities). For example, different playback devices in a bonded group can play back different channels of multi-channel audio content in synchrony with one another. Groups, including bonded groups, may be named based on rooms or other spaces within the environment 100 or may be given other identifying names by the user 210, for example.

In some implementations, multiple playback devices 112 may be bonded to form a bonded group, as described above. For example, referring to FIG. 5A, the playback device 112a can be bonded to the playback device 112b. As described above, bonded playback devices may have different playback responsibilities, such as responsibilities for certain audio channels. For example, the pair of playback devices 112a, 112b shown in FIG. 5A may be bonded so as to produce or enhance a stereo effect of audio content (e.g., to form a stereo pair). In this example, the playback device 112a may be configured to play a left channel audio component, while the playback device 112b may be configured to play a right channel audio component.

Additionally, bonded playback devices may have additional and/or different respective speaker drivers. For example, referring to FIG. 5B, the playback device 112e may be bonded with a playback device 112k and with the playback devices 112d and 112f to form a home theater group. In such examples, the different playback devices in the bonded group can have different audio channel responsibilities and/or different frequency responsibilities. For example, the playback device 112e can be configured to render a range of mid to high frequencies and the playback device 112k can be configured to render low frequencies. When unbonded, however, the playback device 112e may be configured to render a full range of frequencies. In some implementations, the playback devices 112d and 112f can be configured to form surround or “satellite” channels of the home theater system (e.g., left and right surround channels).

Playback devices 112 can be grouped and ungrouped in numerous ways. In addition, group assignments can change over time. Playback devices may be dynamically grouped and ungrouped to form new or different groups that synchronously play back audio content. For example, the user 210 can add and/or remove groups or playback spaces using the graphical user interface 404 of the control device 114. The user 210 may also add or remove playback devices 112 to/from groups using the graphical user interface 404 of the control device 114. In some examples, a group may be provided for control as a single user interface entity (e.g., “Bedroom 1”). Furthermore, in some examples, playback devices 112 may automatically join or leave groups based on detected movement or other conditions.

For example, referring to FIG. 5C, playback devices 112h and 112g may be bonded or otherwise grouped to form a group (e.g., “kitchen/dining area”). When the portable playback device 112j enters the kitchen 102e or dining area 102g, for example, the portable playback device 112j may be added to the group comprising the playback devices 112h and 112g. For example, the user may manually add the portable playback device 112j to the group, or the media playback system 110 may automatically add the portable playback device 112j to the group upon detecting that the portable playback device 112j is within a certain proximity to either or both of the playback devices 112h and/or 112g, for example. In some examples, proximity detection can be accomplished using radio or acoustic signaling. For example, playback devices can be configured to emit signals and to detect signals emitted from other playback devices. Based on signal strength (e.g., RSSI values) and/or other measures of the received signals at various playback devices (and/or at the control device 114), the media playback system 110 may determine an estimate of the proximity of one playback device to another, for example. Examples of techniques for localizing playback devices based on RSSI measurements are disclosed, for example, in U.S. Patent Publication No. 2021/0099736 titled “Systems and Methods for Playback Device Management” and filed on January 28, 2020, which is herein incorporated by reference in its entirety. Examples of playback devices equipped with ultrasonic presence detection are disclosed, for example, in U.S. Patent Publication No. 2022/0066008, titled “Ultrasonic Transmission for Presence Detection” and filed on August 30, 2021, which is herein incorporated by reference in its entirety.

FIG. 5D illustrates another example in which the portable playback device 112i may automatically join a group based on being placed on the docking station 116. In the illustrated example, the docking station 116 is associated with a home theater bonded group comprising the playback devices 112d, 112e, and 112k, as described above. When the portable playback device 112i is placed on the docking station 116, the portable playback device 112i may become a satellite playback device in the home theater bonded group, for example.

Numerous other examples and configurations are possible, as will be appreciated, given the benefit of this disclosure, and are intended to be part of this disclosure.

As noted above, in some examples, groups of playback devices 112 can be combined (or grouped together) to form an “area.” An area may involve a cluster of two or more groups, for example, and can be used to distinguish a group of individual playback devices. For example, the user 210 may have a home theater bonded group comprising the playback devices 112e, 112d, 112f, and 112k along with a stereo bonded group comprising the playback devices 112h and 112g. The user 210 may form an area (e.g., “living space”) that comprises the two groups. This grouping of groups of playback devices to form areas may allow the user to form larger combinations of playback devices 112 more quickly than by forming a new group and adding numerous individual playback devices, for example. Areas can be named based on a combination of the names of individual playback spaces or groups within the area, or may be given unique names selected by the user 210. Further examples of techniques for implementing Areas may be found, for example, in U.S. Patent No. 10,712,997 titled “Room Association Based on Name,” and U.S. Patent No. 8,483,853 titled “Controlling and manipulating groupings in a multi-zone media system,” each of which is incorporated herein by reference in its entirety.

Certain data may be stored in a memory of a playback device (e.g., the memory 334) as one or more state variables that are periodically updated and used to describe the state of a playback group, the playback device(s), and/or an area associated therewith. The memory may also include the data associated with the state of the other devices of the media playback system 110, and shared from time to time among the devices so that one or more of the devices have the most recent data associated with the system, as described above. In some examples, the memory may store instances of various variable types associated with the states. Variable instances may be stored with identifiers (e.g., tags) corresponding to type. For example, certain identifiers may be a first type to identify playback device(s) of a group, a second type to identify playback device(s) that may be bonded in the group, and a third type to identify an area (or combination group) to which the group may belong. For example, identifiers associated with the second bedroom 102c may indicate that the playback device 112c is the only playback device of a “Bedroom 2” group and not in an area. Identifiers associated with the dining area 102g may indicate that the dining area is part of a Dining + Kitchen area and that the playback devices 112h and 112g are grouped (e.g., as described above with reference to FIG. 5C). Identifiers associated with the kitchen 102e may indicate the same or similar information by virtue of the kitchen being part of the Dining + Kitchen area, for example. In other examples, the media playback system 110 may not implement areas.

### III Foldable Playback Device

Examples described herein relate to new hardware and software technology for a foldable playback device, an adaptive user interface disposed on the foldable playback device, and techniques for dynamically updating playback device configuration based on a physical orientation of the foldable playback device.

In general, the disclosed foldable playback device may comprise one or more structural components that may be included in any of the playback devices described above. For instance, the disclosed foldable playback device may comprise one or more of the structural components 310-370 that are included in the playback device 112 discussed above with reference to FIG. 3B, such as, for example, the user interface 310, the microphone(s) 370, and the transducer(s) 344, discussed above with reference to FIG. 3C and FIG. 3D.

Notably, in accordance with the present disclosure, the user interface of the foldable playback device may comprise an adaptive user interface that is disposed on a surface of the foldable playback device. The adaptive user interface of the foldable playback device may enable control of multiple different settings (e.g., a volume setting, a media playback setting, etc.) of the foldable playback device and may be uniquely positioned on an external surface of the playback device in a way that contemplates various adjustable physical orientations of the foldable playback device discussed herein. For instance, the adaptive user interface may be configured to dynamically adapt to changes in the orientation of the foldable playback device such that the adaptive user interface is accessible for user interaction regardless of the orientation of the foldable playback device. Advantageously, the adaptive user interface may be configured so as to take up minimal real estate on the surface of the foldable playback device while providing necessary control options for controlling different aspects of the foldable playback device.

The foldable playback device may further comprise one or more enclosures that house one or more of the structural components of the foldable playback device. For instance, the disclosed foldable playback device may generally comprise at least two transducers, and the one or more enclosures may house the transducers of the foldable playback device. In line with the disclosed technology, the one or more enclosures of the foldable playback device may be moveable so as to position the foldable playback device in different orientations (e.g., different physical orientations).

Advantageously, the different orientations in which the foldable playback device may be positioned may each provide a particular type of listening experience. For instance, the different orientations of the foldable playback device may provide different levels of force cancellation between transducers, different playback modes, or different group configurations, among other possibilities.

Further, the foldable playback device may be configured for magnetic engagement with other devices (e.g., MagSafe-compatible) such that the foldable playback device may be attached to, or otherwise used in conjunction with, magnetically enabled devices, such as magnetic chargers (e.g., for wireless charging), or magnetically-enabled computing devices (e.g., for different group configurations and/or operational modes), as will be described in more detail further below, among other possibilities.

The disclosed foldable device may take various forms. In one implementation, the disclosed foldable device may include two enclosures each housing a respective transducer, a hinge that movably connects the two enclosures such that the foldable device may be positioned in different orientations as disclosed herein, and an adaptive user interface disposed on the hinge.

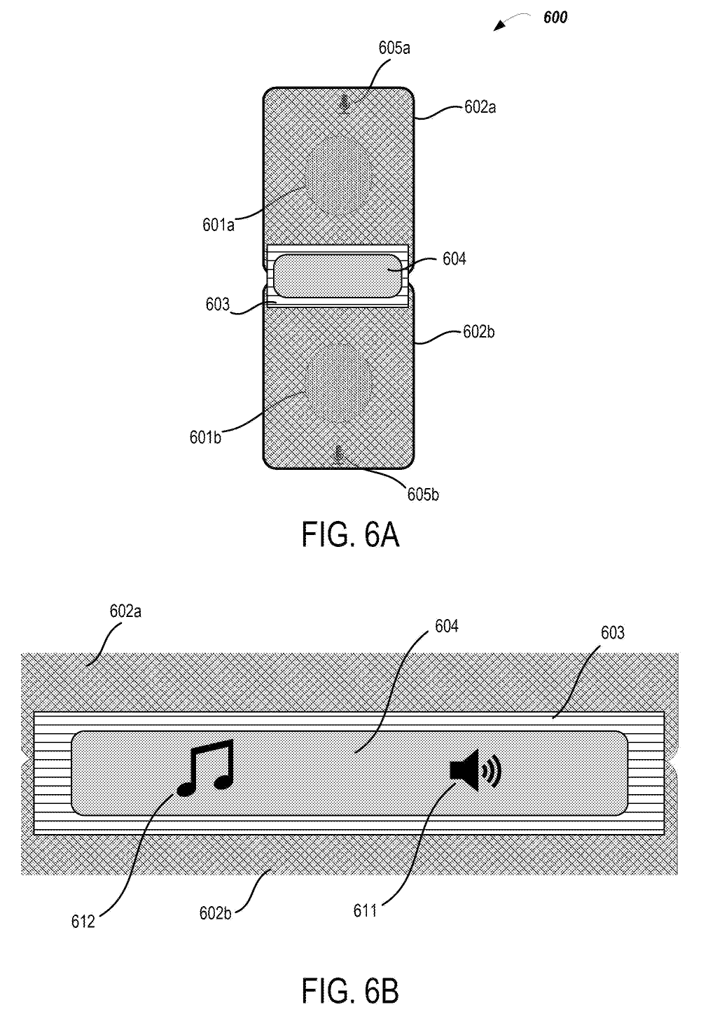

FIG. 6A depicts a front-facing view of an example foldable playback device 600 according to one possible implementation of the disclosed technology. In the example of FIG. 6A, the foldable playback device 600 comprises a first transducer 601a housed in a first enclosure 602a and a second transducer 601b housed in a second enclosure 602b. The transducers 601a and 601b of the foldable playback device 600 may take various forms. For instance, the transducers 601a and 601b may comprise transducers that are capable of producing multi-directional sound, transducers that are capable of producing omni-directional sound, or a combination thereof, among other possibilities.

Additionally, the foldable playback device may comprise a hinge 603 that movably connects the first and second enclosures 602a and 602b such that the first and second transducers 601a and 601b may be positioned in different physical orientations relative to one another. Advantageously, this enables the transducers 601a and 601b to be arranged in different positions depending on the playback goals of the user. In some examples, the transducers 601a and 601b may be positioned in order to control vibrations that may be produced during playback of media content by the foldable playback device 600 so as to implement force cancellation and thereby enhance the quality of the media playback.

As shown in FIG. 6A, the hinge 603 may facilitate movement of one or both of the enclosures 602a or 602b to adjust the orientation of the foldable playback device. For instance, one or both of the enclosures 602a or 602b may be moveable (e.g., capable of being adjusted manually by a user of the foldable playback device 600, capable of being adjusted dynamically by the foldable playback device 600, etc.) rotationally around the hinge 603 to place the enclosure(s) into different positions. For instance, the enclosures 602a or 602b may rotate around the hinge 603 within a given range (e.g., 0-180 degrees, 0-360 degrees, etc.) to be arranged in different positions. In the example of FIG. 6, the enclosures 602a and 602b are arranged side-by-side in a “flat” or “open” position such that the foldable playback device 600 is placed in an orientation that forms a 180-degree angle. However, other orientations are also possible, as will be described in more detail further below.

The different positions may be determined in various ways. For instance, as one possibility, such as in the example of FIG. 6A, the hinge 603 may comprise a set of notches such that each notch serves to indicate (e.g., to a user that is manually manipulating the foldable playback device 600) a predetermined fixed position into which an enclosure 602a or 602b may be placed. For instance, each notch may serve as a stopping point to receive and hold an enclosure in place, and a user may move one or both of the enclosures 602a or 602b into a given position based on aligning one or both of the enclosures 602a or 602b with a given notch of the hinge 603. In some instances, the hinge 603 may comprise a visual indication of each notch so the user can see the various different positions into which an enclosure may be arranged. As another possibility, the hinge 603 may enable one or both of the enclosures 602a or 602b to be rotated freely within a given range around the hinge 603 (e.g., 0-180 degrees, 0-360 degrees, etc.) such that one or both of the enclosures 602a or 602b may be moved into any position within the given range. Other examples are also possible.

Further yet, the hinge 603 may comprise an adaptive user interface 604 that can be used to control various playback, operational, and/or configuration settings of the foldable playback device 600. The adaptive user interface 604 may take various forms.

For instance, as one possibility, the adaptive user interface 604 may comprise one or more control buttons for providing user input to control the various aspects of the playback device 600. As one example, the adaptive user interface 604 may comprise one or more physical buttons. As another example, the adaptive user interface 604 may comprise one or more capacitive touch control buttons. As yet another example, the adaptive user interface 604 may comprise a combination of one or more physical and capacitive control buttons. In some implementations, the adaptive user interface 604 may be dual-sided such that the adaptive user interface 604 comprises a mirrored set of control buttons on either side. In this respect, the adaptive user interface 604 may be adaptive such that the respective control buttons of a particular side may be activated depending on an orientation of the foldable playback device 600. For instance, the adaptive user interface 604 may be configured to power on/power off or otherwise adjust the sensitivity of the various buttons of the adaptive user interface 604 depending on the orientation of the foldable playback device 600.

In some implementations where the adaptive user interface 604 comprises a capacitive touch interface, the capacitive touch interface may be configured to dynamically display one or more control buttons based on one or more touch inputs received at the capacitive touch interface. For instance, as one example, the capacitive touch interface may be activated via a first touch input to display one or more control buttons and may dynamically display additional buttons based on further touch input(s). In other implementations, the capacitive touch interface may comprise a fixed set of control buttons.

Further, in line with the discussion above, in some implementations, the capacitive touch interface may be dual-sided such that the capacitive touch interface is disposed on either side of the hinge 603 and configured to receive user input from either side of the hinge 603. In some such implementations, as one possibility, the capacitive touch interface may be adaptive so as to activate a particular side of the capacitive touch interface depending on an orientation of the foldable playback device 600. For instance, the capacitive touch interface may be configured to power on/power off or otherwise adjust the sensitivity of a given side of the capacitive touch interface depending on the orientation of the foldable playback device 600. In some such implementations, as another possibility, each side of the capacitive touch interface may comprise buttons corresponding to a respective set of controls. For instance, as one possibility, a first side of the adaptive user interface may comprise buttons corresponding to corresponding to a first set of “personalized” controls, such as controls based on settings that are associated with a user of the foldable playback device, and a second side of the adaptive user interface may comprise buttons corresponding to a second set of “public” controls that are different from or more limited than the first set, such as a set of controls that comprises only generic playback controls (e.g., play/pause, skip, volume control, etc.). For instance, the user may have configured certain playback settings or media content settings to curate personalized listening experiences, and such settings may be controlled via the personalized adaptive user interface. In some implementations, the public and private controls may be configured to be displayed on respective sides of the hinge 603 depending on a current orientation of the foldable playback device. For instance, as will be described in more detail further below, the foldable playback device may be positioned in one or more orientations with varying degrees of “openness.” In such instances, the personalized adaptive user interface may be displayed on an “inner” side of the hinge, and the public adaptive user interface may be disposed on an “outer” side of the hinge. Other examples are also possible.

The types of controls that may be facilitated by the adaptive user interface 604 may take various forms. For instance, as one possibility, the adaptive user interface 604 may provide media playback control options that enable a user to control media content being played back by the foldable playback device 600, which may include, for example, controls to play, pause, or skip media content, among other possibilities. As another possibility, the adaptive user interface 604 may provide volume control options that enable a user to control a volume of media content being played back by the foldable playback device 600. As another possibility, the adaptive user interface 604 may provide grouping control options that enable a user to control grouping behavior of the foldable playback device 600. As yet another possibility, the adaptive user interface 604 may provide operational mode control options that enable a user to control an operation mode of the foldable playback device 600, such as operating in a mono channel playback mode, operating in a stereo channel playback mode, operating in a home theater mode, operating in a subwoofer mode, or operating in a speakerphone mode, among other possibilities. Further, as another possibility, the adaptive user interface 604 may provide control options that enable a user to adjust one or more playback settings of the foldable playback device 600, such as equalization settings, grouping behavior settings, or operation mode settings. The adaptive user interface 604 may provide other control options as well.

A close-up view of the adaptive user interface 604 shown in FIG. 6A is provided in FIG. 6B. FIG. 6B provides one example of an adaptive user interface 604 that takes the form of a capacitive touch interface. For instance, as shown in FIG. 6B, the adaptive user interface 604 may comprise a first button 610 and a second button 611 that may be selected to control media playback and volume settings, respectively, of the playback device 600. However, depending on the implementation, the adaptive user interface 604 may comprise additional control buttons corresponding to other control options as well, in line with the discussion above.

Further still, the foldable playback device 600 may comprise one or more microphones for detecting audio input. Depending on the implementation, the microphone(s) may be located on one or both of the enclosures 602a or 602b or on the hinge 603, perhaps as part of the adaptive user interface 604. For instance, in the example of FIG. 6, the foldable playback device 600 may comprise a first microphone 605a located on the first enclosure 602a and a second microphone 605b located on the second enclosure 602b. Further, in some implementations, the foldable playback device 600 may be configured to disable one or both of the microphones when the foldable playback device 600 is in a given orientation. For instance, in one example orientation, as will be described in more detail further below, the foldable playback device 600 may be positioned in a “closed” or “folded” orientation such that the enclosures 602a and 602b are arranged back-to-back, in which case the foldable playback device 600 may disable a given one of the microphones 605a or 605b so that only one of the microphones detects audio input (e.g., voice input from a user). Further, in another example orientation, as will be described in more detail further below, the foldable playback device 600 may be connected to a computing device such as a smartphone to play back certain audio frequencies (e.g., bass frequencies) or to provide support as a speakerphone, in which case the foldable playback device 600 may disable both of the microphones 605a or 605b, and a respective microphone of the smartphone may be available to detect voice input for any commands that are to be carried out by the foldable playback device 600. Other examples are also possible.

Further yet, in some implementations, the adaptive user interface 604 may include one or more visual indicators. For instance, as one possibility, the adaptive user interface 604 may include one or more LED lights for providing visual indications. As another possibility, the adaptive user interface 604 may comprise a display screen for providing visual indications and other information to a user of the foldable playback device 600.

It should be understood that the foldable playback device 600 may additionally comprise any one or more of the components 310-370 discussed above with reference to FIGS. 3B-3C.

In the examples above, while the foldable playback device 600 is described as comprising two enclosures each housing respective transducers, depending on the implementation, it is possible that a given one of the enclosures may house both transducers. For instance, in one implementation, both transducers 601a and 601b, along with other components of the foldable playback device 600 as described above, may be housed in a first enclosure, and the second enclosure may house the adaptive user interface 604, thereby providing a larger surface area for the adaptive user interface 604, which may allow for additional user interface components such as a display screen, in line with the discussion above.

The foldable playback device 600 may take other forms as well.

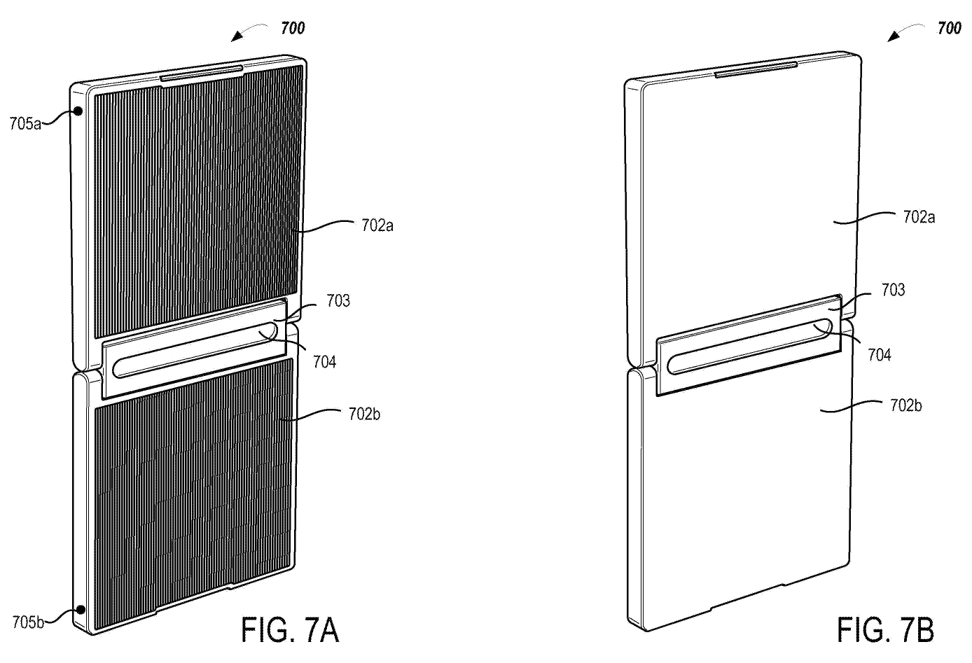

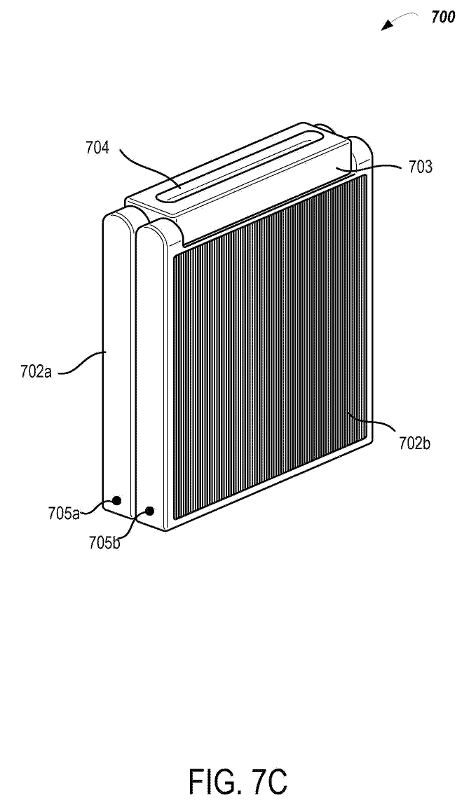

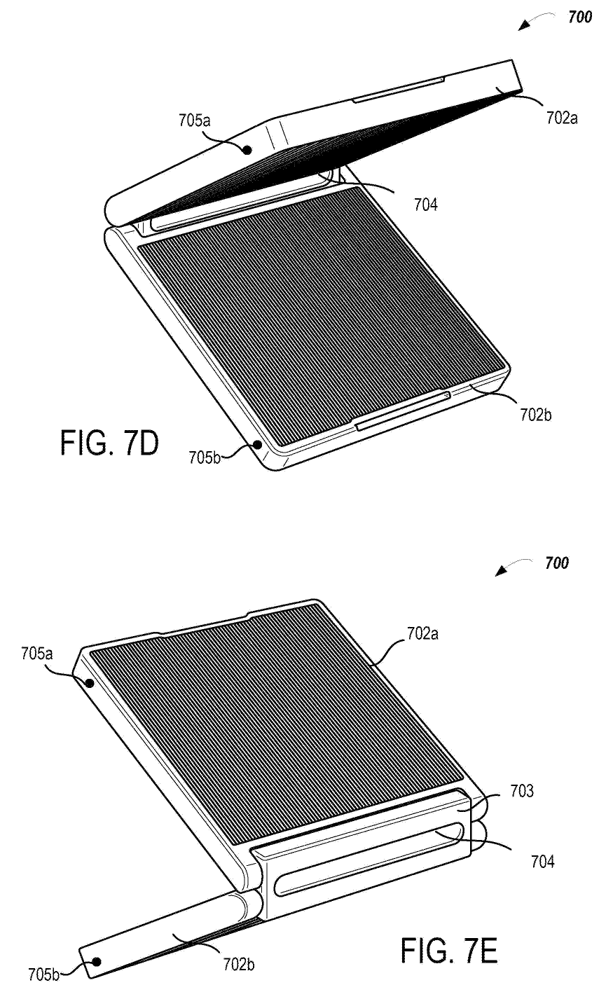

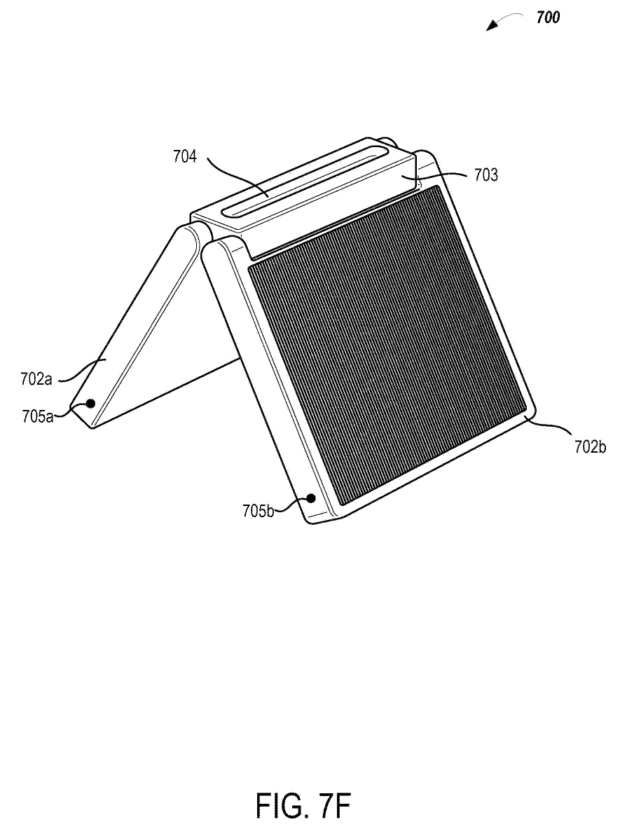

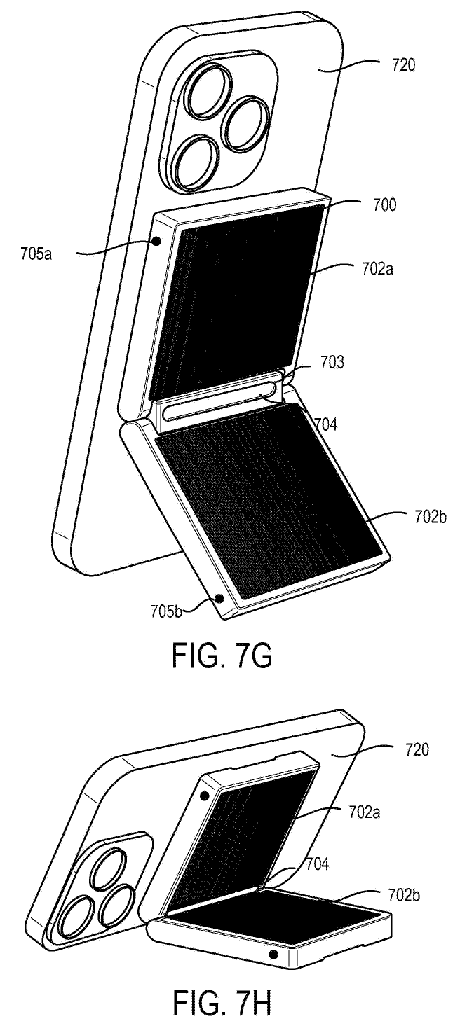

Turning now to FIGs.7A-7F, some examples of possible orientations into which the disclosed foldable playback device may be positioned are shown. The examples of FIG. 7A-7E may involve a foldable playback device 700, which may be similar to, and comprise one or more components as described above with reference to, the foldable playback device 600 shown in FIG. 6. For instance, the foldable playback device 700 may comprise a first enclosure 702a housing a first transducer, a second enclosure 702b housing a second transducer, a hinge 703 comprising an adaptive user interface 704, and microphones 705a and 705b, along with other components that are not shown.

With reference first to FIG. 7A, a front-facing view of the foldable playback device 700 in a “flat” orientation is shown. In the flat orientation, the enclosures 702a and 702b may be arranged side-by-side (i.e., facing the same direction) at a 180-degree angle. Further, the adaptive user interface 704 may be accessible from the front side of the foldable playback device 700 for user interaction. Turning now to FIG. 7B, a rear-facing view of the foldable playback device 700 in the flat orientation of FIG. 7A is shown. Notably, as shown in FIG. 7B, the adaptive user interface 704 may be adapted for user accessibility from the rear side of the foldable playback device 700. In the flat orientation, the foldable playback device 700 may be configured to direct the audio playback of both transducers in the same direction, which may be desirable for some listening scenarios.

Alternatively, the user may wish to adjust the enclosures 702a and/or 702b to position the foldable playback device 700 in a different orientation that facilitates multi-directional audio playback, and in a way that enables force cancellation between the two transducers. For instance, as depicted in FIG. 7C, the enclosures 702a and 702b may be arranged back-to-back at a 0-degree angle such that the foldable playback device 700 is positioned in a “closed” orientation. In the closed orientation where the enclosures 702a and 702b are arranged back-to-back, the respective transducers of the enclosures 702a and 702b are arranged in a force canceling arrangement, which may reduce or eliminate the vibrations produced as a byproduct of audio output. This, in turn, may reduce the tendency of the foldable playback device 700 to “bounce” or otherwise move when it is placed on a hard surface, such as a table, during playback.

In some implementations, the foldable playback device 700 may be configured to output an indication regarding force cancellation. For instance, depending on a current orientation, the foldable playback device 700 may be configured to output an indication of whether or not force cancellation is in effect, and/or an indication recommending a given configuration to implement force cancellation.

In line with the discussion above, the foldable playback device 700 may also be positioned in other orientations.

For instance, FIG. 7D depicts a front-facing view of the foldable playback device 700 in an inward “folded” orientation, where the enclosures 702a and 702b are arranged at an angle greater than 180 degrees such that they are facing each other. In this inward folded orientation, the adaptive user interface 704 may be difficult for a user to access from the front side of the foldable playback device 700, as the enclosures 702a and 702b may physically impede access to the adaptive user interface 704 when angled inward. Thus, to alleviate such impediment, the adaptive user interface 704 may conveniently be adapted for user accessibility from the rear side of the foldable playback device 700.

FIG. 7E depicts a front-facing view of the foldable playback device 700 in an outward folded orientation, where the enclosures 702a and 702b are arranged at an angle less than 180 degrees such that they are facing away from each other. In such an outward folded orientation, the adaptive user interface 704 may be adapted for user accessibility from the front side of the foldable playback device 700.

When positioned in any of the orientations as shown in FIGS. 7A-7E, the foldable playback device 700 may be placed along its various edges depending on user preference. For instance, as shown in FIG. 7F, the foldable playback device 700 may be placed along respective edges of the enclosures 702a and 702b such that the foldable playback device 700 is supported in a “tented position,” such that the hinge 703 and adaptive user interface 704 are facing upward. In other examples, the foldable playback device 700 may be placed along respective edges of the enclosures 702a and 702b such that the foldable playback device 700 is supported in an “open book” position, such that the hinge 703 and adaptive user interface 704 are facing outward.

The foldable playback device 700 may be positioned in other orientations as well.

In some implementations, the foldable playback device 700 may be configured to be physically connected to one or more other computing devices. For instance, the foldable playback device 700 may include one or more magnets (e.g., in a MagSafe-compatible configuration) such that it is capable of being magnetically connected to a surface of another computing device. For example, the foldable playback device 700 may be positioned in an orientation in which one or more enclosures of the foldable playback device 700 is connected to another computing device, such as a smartphone, a tablet, a non-foldable playback device, or another foldable playback device. FIGS. 7G and 7H depict examples in which the foldable playback device 700 is magnetically connected to another computing device.

For example, FIG. 7G depicts an example where the foldable playback device 700 is magnetically connected to a smartphone computing device 720 when the computing device 720 is positioned in a portrait mode, such that the entire rear side of the enclosure 702a is in contact with the computing device 720 and resting along an edge of the enclosure 702b. In turn, FIG. 7H depicts an example where the foldable playback device 700 is magnetically connected to the smartphone computing device 720 when the computing device 720 is positioned in a landscape mode, such that the entire rear side of the enclosure 702a is in contact with the computing device 720 and resting along the entire rear side of the enclosure 702b. Each of these configurations may correspond to a particular operational mode of the foldable playback device 700, which may be activated either manually or automatically upon connection to the computing device 720, as discussed further below.

Further, in some implementations, the foldable playback device 700 may connect to a second foldable playback device. For instance, an edge of a first enclosure of the foldable playback device 700 may connect to an edge of a respective first enclosure of the second foldable playback device, or the first enclosure of the foldable playback device 700 may overlap with the respective first enclosure of the second foldable playback device.

Further yet, in some implementations, the foldable playback device 700 may connect to a non-foldable playback device.

Further still, in some implementations, the foldable playback device 700 may connect to one or more other playback devices (foldable or non-foldable) via a chain of playback devices that are magnetically connected.

Many other examples of orientations of the foldable playback device 700 are possible.

In the examples above, the hinge of the disclosed foldable playback device is described as a stationary hinge. However, in other implementations, the hinge may comprise a movable hinge that can be moved to facilitate positioning the foldable playback device into different orientations, including any of the different orientations described above. For instance, as one possibility, the moveable hinge may comprise a slidable hinge that can slide away from the one or more enclosures of the foldable playback device when the foldable playback device is positioned in a more open orientation (e.g., flat orientation). Further, the moveable hinge may be configured to slide under one or both of the enclosures of the foldable playback device when the foldable playback device is in a more compact orientation (e.g., folded or closed orientation). In this way, the movable hinge may be configured to provide a larger surface area on which the adaptive user interface is disposed, yet may conveniently be stowed away when necessary.

As another possibility, the moveable hinge may comprise a rotating hinge that can be rotated inward so as to rotate under one or more of the enclosures of the foldable playback device (e.g., when the foldable playback device is in an open orientation) and rotated outward so as to rotate away from the one or more enclosures (e.g., when the foldable playback device is in a compact orientation).

Further yet, in some implementations, the foldable playback device may comprise two or more hinges that enable the foldable playback device to be positioned in additional configurations. In such implementations, the two or more hinges may comprise any combination of stationary or moveable hinges as discussed herein.

The foldable playback device may be placed in other orientations as well.

In some implementations, the different orientations in which the disclosed foldable playback device may be positioned may correspond to a respective operational mode of the foldable playback device. For instance, as one possibility, when the foldable playback device is positioned in a closed orientation such that the first and second enclosures are positioned back-to-back, the foldable playback device may be configured to operate in a first operational mode (e.g., mono-channel mode). As another possibility, when the foldable playback device is positioned in a folded orientation (e.g., within a particular angle range), the foldable playback device may be configured to operate in a second operational mode (e.g., stereo-channel mode). As yet another possibility, when the foldable playback device is positioned in a flat orientation, the foldable playback device may be configured to operate in a third operational mode.

Further, as another possibility, when the foldable playback device is connected to a smartphone device, the foldable playback device may be configured to operate in a fourth operational mode. For example, when connected to a smartphone that is playing back media content (e.g., music content, audio content corresponding to video content that is playing via the smartphone’s display, etc.), the foldable playback device may be configured to play back certain audio frequencies (e.g., bass frequencies) while the smartphone plays back other audio frequencies (e.g., stereo, mono). Alternatively, the foldable playback device may handle all audio output corresponding to the video output of the smartphone. As yet another example, the foldable playback device may be configured to operate as a speakerphone such that audio content played by the smartphone is amplified via the foldable playback device. Other examples are also possible.

Further yet, as another possibility, when the foldable playback device is connected to another foldable playback device, the foldable playback device may be configured to operate in a fifth operational mode. For instance, the foldable playback device may be configured to play back certain channels of audio (e.g., left or right stereo channels) and/or create a certain audio environment in synchrony with the other foldable playback device. For example, the foldable playback device may be configured to play back audio directed in a first direction (e.g., upward/vertically) in synchrony with playback of audio by the other foldable playback device directed in a second direction (e.g., laterally) to create a surround sound or immersive audio environment. As another example, the foldable playback device may be configured to play back certain ambient sounds to create a particular audio scene in synchrony with the other foldable playback device. Other examples are also possible.

Further still, as another possibility, when the foldable playback device is connected to a non-foldable playback device (e.g., a stationary speaker, a soundbar, etc.), the foldable playback device may be configured to operate in an operational mode that matches a current operational mode of the non-foldable playback device. For instance, as one example, if the non-foldable playback device is part of a synchrony group (e.g., home theater group, etc.) the foldable playback device may play back, in synchrony with the non-foldable playback device, audio content that corresponds to video content being displayed at a display device. As another example, if the non-foldable playback device is a soundbar, the foldable playback device may be configured to provide extended playback capability for the soundbar. For instance, the foldable playback device may be configured to mimic the soundbar’s playback behavior to play back audio in one or more directions or to play back certain audio channels or audio frequencies, for example, to support soundbar audio playback, which may be useful as an expandable soundbar.

The foldable playback device may be configured to operate in other modes as well.

In line with the disclosed technology, the foldable playback device may be configured to determine a change in an orientation of the foldable playback device, based on which the foldable playback device may transition from operating in a current operational mode to operating in a different operational mode. The foldable playback device may determine a change to an orientation of the foldable playback device in various ways. For instance, as one possibility, the foldable playback device may determine a change to an orientation based on detecting, via one or more sensors (e.g., a rotary encoder, accelerometer, gyroscope, microphone, etc.), a change in a position of one or more enclosures of the foldable playback device. For example, the foldable playback device may determine that a given enclosure has moved relative to a hinge of the foldable playback device. As another example, the foldable playback device may determine that a distance between a first enclosure and a second enclosure has changed. As one possibility, a microphone on one or both enclosures may detect the sound output of the other enclosure and thereby determine the position of the other enclosure. Other examples are also possible. The foldable playback device may determine a change to an orientation of the foldable playback device in other ways as well.

In some implementations, the foldable playback device may be configured to determine a particular orientation that is likely to provide an optimal listening experience. In this respect, the foldable playback device may evaluate one or more characteristics to determine the particular orientation. The one or more characteristics may take various forms. As one possibility, based on determining location, distance, and/or orientation information via one or more sensors (e.g., a rotary encoder, an accelerometer, a gyroscope, a microphone, a magnet, a network interface, a calibration sensor system, etc.), the foldable playback device may evaluate one or more environmental characteristics of an environment in which the foldable playback device is located, such as a size of the environment, one or more objects within a given proximity of the foldable playback device, and/or a location of one or more users within a given proximity of the foldable playback device, based on which the foldable playback device may determine the particular orientation. For instance, as one example, the foldable playback device may determine (e.g., based on voice input detected via one or more microphones) that the environment comprises two listeners located on either side of the foldable playback device and that a tented orientation would provide an optimal listening experience for both listeners. As another example, the foldable playback device may determine (e.g., based on Bluetooth communication) that a non-foldable playback device that is part of a home theater synchrony group is located within a given proximity of the foldable playback device and that an orientation in which the foldable playback device is physically connected to the non-foldable playback device would provide an optimal listening experience. As yet another example, the foldable playback device may determine (e.g., based on detecting via the calibration sensor system), that it has been placed near a wall or other large object, and that an open book orientation would provide an optimal listening experience.

As another possibility, the foldable playback device may evaluate one or more characteristics of given media content that has been identified for playback by the foldable playback device, based on which the foldable playback device may determine the particular orientation. For instance, the foldable playback device may determine that the given media content comprises mono-channel audio and that a closed orientation would provide an optimal listening experience. As yet another possibility, the foldable playback device may evaluate one or more characteristics associated with a user of the foldable playback device, based on which the foldable playback device may determine the particular orientation. For instance, the user of the foldable playback device may have configured certain settings (e.g., equalization settings, bass settings, immersive sound settings, etc.), such as via a software application for managing aspects of a media playback system including the foldable playback device, and the foldable playback device may determine the particular orientation based on one or more of those settings. Many other examples are possible.

In some implementations, based on determining a particular orientation that is likely to provide an optimal listening experience, the foldable playback device may output an indication recommending the particular orientation in order to facilitate manual positioning of the foldable playback device into the particular orientation. The indication recommending the particular orientation may take various forms. As one possibility, the foldable playback device may output an audio recommendation indicating the particular orientation. As another possibility, the foldable playback device may output a visual recommendation indicating the particular orientation. For instance, as one example, the foldable playback device may output, via one or more LED lights, a particular light color corresponding to the particular orientation. As another example, the foldable playback device may output, via a display, an indication of the particular orientation. As yet another example, the foldable playback device may cause a control device to output an audio and/or visual indication of the particular orientation. In some implementations, the foldable playback device may output one or more visual and/or audio indications that guide a user in real-time for positioning the foldable playback device into the particular orientation.

In some implementations, based on determining a particular orientation that is likely to provide an optimal listening experience, the foldable playback device may be configured to dynamically update an orientation of the foldable playback device. In such implementations, one or more components of the foldable playback device may be motorized. For instance, the hinge and/or one or more of enclosures may be motorized such that the foldable playback device is configured to cause the hinge and/or an enclosure to move such that the foldable playback device is positioned in the particular orientation.

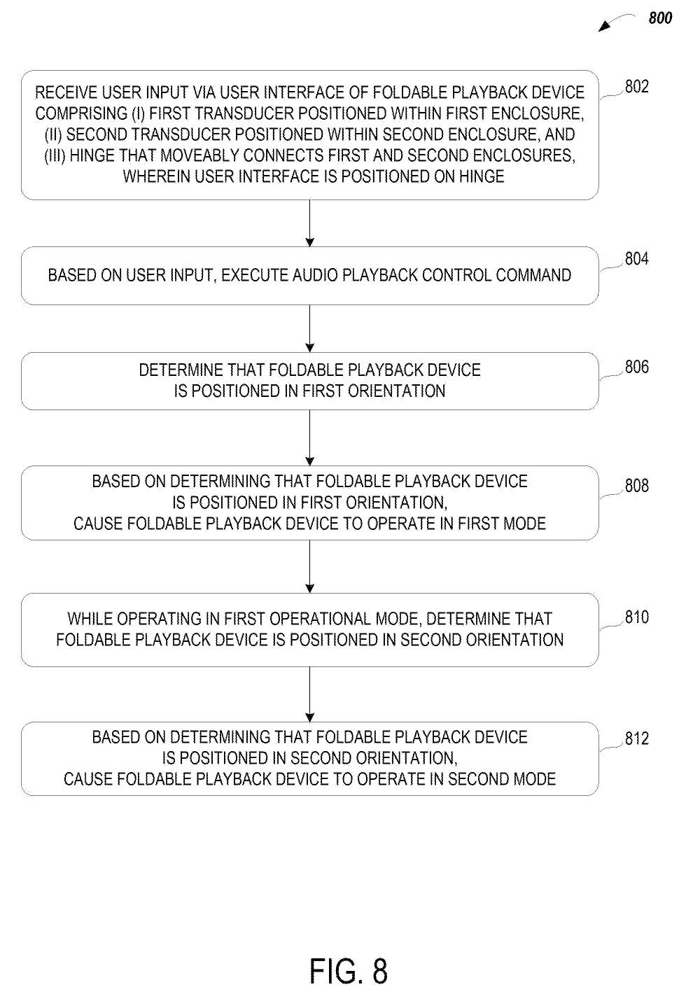

Turning now to FIG. 8, a flow diagram is provided that depicts example functionality 800 for transitioning operational modes of a foldable playback device as disclosed herein in accordance with one embodiment of the disclosed technology. The example functionality 800 may be carried out by a foldable playback device comprising at least a first enclosure housing a first transducer, a second enclosure housing a second transducer, and a hinge comprising a user interface, wherein the hinge movably connects the first and second enclosures. In this respect, the foldable playback device may resemble any of the foldable playback devices 600 or 700 described above.

The example functionality 800 may begin at 802, where the foldable playback device may receive user input via at least one button of the user interface. In line with the discussion above, the user interface may comprise an adaptive user interface that comprises at least one physical or capacitive button that can be used to provide the user input.

At 804, based on the user input, the foldable playback device may execute an audio playback command. In line with the discussion above, the audio playback command may comprise any of various commands, such as a command to play back given audio content, a command to adjust a volume level, or a grouping command.

At 806, the foldable playback device may determine that the foldable playback device is positioned in a first orientation. For instance, in line with the discussion above, the foldable playback device may make this determination based on evaluating one or more characteristics via one or more sensors of the foldable playback device, among other possibilities.

In turn, based on determining that the foldable playback device is positioned in the first orientation, at 808, the foldable playback device may operate in a first operational mode. For example, in line with the discussion above, the foldable playback device may determine that it is positioned in a first orientation, such as a flat, a tented, or a closed orientation, and may thus operate in an operational mode in which the foldable playback device is configured to play back media content in mono-channel mode.

At 810, while operating in the first operational mode, the foldable playback device may determine that its orientation has changed, and that it is now positioned in a second orientation. For example, the foldable playback device may determine that it has been connected to a second playback device, such as a smartphone or another foldable playback device that is currently playing back given media content.

In turn, at 812, based on determining that the foldable playback device is in the second orientation, the foldable playback device may transition from operating in the first operational mode to operating in a second operational mode. For example, the foldable playback device may transition from playing back the media content in mono-channel mode to playing back the given media content in synchrony with the second playback device in multi-channel mode. Other examples are also possible as discussed above.

In line with the discussion above, the hardware and software technology comprising the foldable playback device, adaptive user interface, and configuration techniques disclosed herein provide several advantages over existing technology for portable playback devices and on-product user interfaces. For instance, the disclosed foldable playback device is conveniently portable while also capable of providing high fidelity listening experiences. For instance, the foldable playback device may be the size of, or even smaller than, a computing device such as a smartphone or tablet, and can thus be easily carried by a user on the go. Further, the movable enclosures enable the foldable playback device to perform force cancellation, which is typically difficult to achieve using existing portable playback devices. Further yet, the range of motion of the moveable enclosures enables the foldable playback device to be positioned in any of various different orientations, thereby enabling different acoustical configurations, enhanced immersive audio experiences, and targeted directional sound. Further still, the adaptive user interface positioned on a hinge of the foldable playback device enables positioning the foldable playback device in the various different orientations while alleviating any restrictions that would otherwise cause the foldable playback device to remain in a fixed position relative to the adaptive user interface. In the ways disclosed above, the foldable playback device provides increased flexibility and customizability for positioning the foldable playback device in various orientations comprising various angles.

### IV. Conclusion

The above discussions relating to playback devices, control devices, playback zone configurations, and media content sources provide only some examples of operating environments within which functions and methods described herein may be implemented. Other operating environments and configurations of media playback systems, playback devices, and network devices not explicitly articulated as part of this disclosure may also be applicable and suitable for implementation of the functions and methods described herein.

The description above discloses, among other things, various example systems, methods, apparatus, and articles of manufacture including, among others, firmware and/or software code executed on hardware. It is understood that such examples are merely illustrative and should not be considered as limiting. For example, it is contemplated that any or all of the firmware, hardware, and/or software aspects can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “example” mean that a particular element, structure, or characteristic described in connection with the example can be included in at least one example of the technology described herein. The appearances of these terms in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

No appended claim is to be read to cover a purely software and/or firmware implementation. Each claim reciting code is hereby expressly defined to include a tangible, non-transitory medium such as a memory, DVD, CD, Blu-ray, and so on, storing the code.

1. A foldable playback device comprising:
a first transducer positioned within a first enclosure;
a second transducer positioned within a second enclosure;
a hinge that movably connects the first enclosure and the second enclosure, wherein the hinge facilitates positioning the foldable playback device in at least a first orientation in which the first transducer and the second transducer are arranged back-to-back and a second orientation in which the first transducer and the second transducer are arranged side-by-side;
a user interface positioned on the hinge, the user interface comprising at least one button;
at least one processor;
at least one non-transitory computer-readable medium; and
program instructions stored on the at least one non-transitory computer-readable medium that are executable by the at least one processor such that the foldable playback device is configured to:
receive a user input via the at least one button; and
based on the user input, execute an audio playback control command.

2. The foldable playback device of claim 1, further comprising program instructions stored on the at least one non-transitory computer-readable medium that are executable by the at least one processor such that the foldable playback device is configured to:
determine that the foldable playback device is positioned in the first orientation;
based on determining that the foldable playback device is positioned in the first orientation, cause the foldable playback device to operate in a first operational mode;
while operating in the first operational mode, determine that the foldable playback device has been positioned in the second orientation; and
based on determining that the foldable playback device has been positioned in the second orientation, cause the foldable playback device to operate in a second operational mode.

3. The foldable playback device of claim 2, wherein each enclosure further comprises at least one respective microphone, and wherein the program instructions that are executable by the at least one processor such that the foldable playback device is configured to operate in the second operational mode further comprise program instructions that are executable by the at least one processor such that the foldable playback device is configured to:
disable the at least one respective microphone of one of the first or second enclosures.

4. The foldable playback device of claim 2, wherein the first operational mode comprises using a single audio channel and wherein the second operational mode comprises using two audio channels.

5. The foldable playback device of claim 1, further comprising program instructions stored on the at least one non-transitory computer-readable medium that are executable by the at least one processor such that the foldable playback device is configured to:
determine an orientation of the foldable playback device using one or both of (i) at least one microphone of the foldable playback device or (ii) at least one sensor of the foldable playback device.

6. The foldable playback device of claim 1, wherein the at least one button of the user interface comprises a capacitive touch sensor.

7. The foldable playback device of claim 1, wherein the user interface further comprises a display.

8. The foldable playback device of claim 7, further comprising program instructions stored on the at least one non-transitory computer-readable medium that are executable by the at least one processor such that the foldable playback device is configured to:
cause the user interface to present information about a current orientation of the foldable playback device.

9. The foldable playback device of claim 7, wherein the hinge facilitates positioning the foldable playback device in a third orientation in which the first transducer and the second transducer are arranged in between the back-to-back and side-by-side arrangements, the foldable playback device further comprising program instructions stored on the at least one non-transitory computer-readable medium that are executable by the at least one processor such that the foldable playback device is configured to:
determine that the foldable playback device has been positioned in the third orientation; and
based on determining that the foldable playback device has been positioned in the third orientation, cause the foldable playback device to operate in a third operational mode.

10. The foldable playback device of claim 9, further comprising program instructions stored on the at least one non-transitory computer-readable medium that are executable by the at least one processor such that the foldable playback device is configured to:
before determining that the foldable playback device has been positioned in the third orientation, perform an evaluation of one or more of (i) characteristics of an environment in which the foldable playback device is located, (ii) settings of a user account associated with the foldable playback device, or (iii) characteristics of media content identified for playback by the foldable playback device;
based on the evaluation, determine an instruction indicating that the foldable playback device is to be positioned in the third configuration; and
cause the user interface to present the instruction indicating that the foldable playback device is to be positioned in the third configuration.

11. The foldable playback device of claim 9, further comprising program instructions stored on the at least one non-transitory computer-readable medium that are executable by the at least one processor such that the foldable playback device is configured to:
determine that the foldable playback device is within a threshold proximity of an additional playback device; and
while operating in the third operational mode, play back media content in synchrony with the additional playback device.

12. The foldable playback device of claim 11, wherein the additional playback device is an additional foldable playback device.

13. The foldable playback device of claim 1, wherein the hinge facilitates positioning the foldable playback device in a fourth orientation in which the first transducer and the second transducer are at least partially facing each other.

14. A non-transitory computer-readable medium, wherein the non-transitory computer-readable medium is provisioned with program instructions that, when executed by at least one processor, cause a foldable playback device comprising (i) a first transducer positioned within a first enclosure, (ii) a second transducer positioned within a second enclosure, (iii) a hinge that movably connects the first enclosure and the second enclosure, wherein the hinge facilitates positioning the foldable playback device in at least a first orientation in which the first transducer and the second transducer are arranged back-to-back and a second orientation in which the first transducer and the second transducer are arranged side-by-side, and (iv) a user interface positioned on the hinge, the user interface comprising at least one button, to:
receive a user input via the at least one button; and
based on the user input, execute an audio playback control command.

15. The non-transitory computer-readable medium of claim 14, wherein the non-transitory computer-readable medium is also provisioned with program instructions that, when executed by at least one processor, cause the foldable playback device to:
determine that the foldable playback device is positioned in the first orientation;
based on determining that the foldable playback device is positioned in the first orientation, cause the foldable playback device to operate in a first operational mode;
while operating in the first operational mode, determine that the foldable playback device has been positioned in the second orientation; and
based on determining that the foldable playback device has been positioned in the second orientation, cause the foldable playback device to operate in a second operational mode.

16. The non-transitory computer-readable medium of claim 15, wherein each enclosure further comprises at least one respective microphone, and wherein the program instructions that, when executed by at least one processor, cause the foldable playback device to operate in the second operational mode further comprise program instructions that, when executed by at least one processor, cause the foldable playback device to:
disable the at least one respective microphone of one of the first or second enclosures.

17. The non-transitory computer-readable medium of claim 15, wherein the first operational mode comprises using a single audio channel and wherein the second operational mode comprises using two audio channels.

18. The non-transitory computer-readable medium of claim 14, wherein the non-transitory computer-readable medium is also provisioned with program instructions that, when executed by at least one processor, cause the foldable playback device to:
determine an orientation of the foldable playback device using one or both of (i) at least one microphone of the foldable playback device or (ii) at least one sensor of the foldable playback device.

19. A method carried out by a foldable playback device, wherein the foldable playback device comprises (i) a first transducer positioned within a first enclosure, (ii) a second transducer positioned within a second enclosure, (iii) a hinge that movably connects the first enclosure and the second enclosure, wherein the hinge facilitates positioning the foldable playback device in at least a first orientation in which the first transducer and the second transducer are arranged back-to-back and a second orientation in which the first transducer and the second transducer are arranged side-by-side, and (iv) a user interface positioned on the hinge, the user interface comprising at least one button, the method comprising:
receiving a user input via the at least one button; and
based on the user input, executing an audio playback control command.

20. The method of claim 19, further comprising:
determining that the foldable playback device is positioned in the first orientation;
based on determining that the foldable playback device is positioned in the first orientation, causing the foldable playback device to operate in a first operational mode;
while operating in the first operational mode, determining that the foldable playback device has been positioned in the second orientation; and
based on determining that the foldable playback device has been positioned in the second orientation, causing the foldable playback device to operate in a second operational mode.
